(19) United States
(12) Patent Application Publication
(10) Pub. No.: US 2018/0341896 A1
(43) Pub. Date: Nov. 29, 2018

(54) Enterprise Construction Project Management and Business Integration System

(71) Applicant: Jason Grimes, Carrollton, TX (US)

(72) Inventor: Jason Grimes, Carrollton, TX (US)

(21) Appl. No.: 15/604,217

(22) Filed: May 24, 2017

(51) Int. Cl. G06Q 10/06; G06Q 20/10; G06Q 30/04; G06F 3/0481; G06F 3/0482

(52) U.S. Cl. CPC G06Q 10/06313; G06Q 20/102; G06F 17/30312; G06F 3/04817; G06F 3/0482; G06Q 30/04

(57) ABSTRACT

The invention is network-based software that enables the Construction industry to create requests for payment, manage payments, and track lien waivers for those payments. If a user is working on a request for payment, and a change is made to a previously created request, the software will automatically update all subsequent requests, including the current request, so that the User does not have to manually update or re-calculate the information within requests.

### BACKGROUND OF INVENTION

### Field of the Invention

The present invention relates to the software that can be used to manage the billing and payment processes used by the Construction industry. More specifically, the present invention relates to effectively creating, modifying, updating, and synchronizing the information necessary for serialized billing statements over a network application.

### Background Information

Construction projects require multiple companies with different skillsets and specialties (such as General Contractors, SubContractors, Owner/Developer, Architects, and/or Engineers) to work together to produce some form of infrastructure, which is typically a building, road or bridge system, park, structure, or vessel. A construction project typically starts with planning, design, bidding, financing, and materials sourcing, and continues until the project is built or otherwise ready for use.

Generally speaking, the Owner/Developer will coordinate with one or more Architects (and/or Engineers) to produce a design, schematic, 3D model, or other visual depiction of the desired outcome. The Owner/Developer will typically select one (or more) General Contractors to manage the overall construction effort. The General Contractor(s) (GC) will work with (or on behalf of) the Owner/Developer to select Sub Contractors that will perform specialty work needed for the project. The GC has many important responsibilities during the lifecycle of a project, which includes managing billing statements, managing change orders, issuing payments, and managing lien waivers.

During the course of a project, the GC and Sub Contractors must consistently communicate with the Architects, Engineers, and/or Owner/Developer regarding the billing statements for the work performed, the materials stored, and/or change orders. To maintain this consistency, the industry uses billing statements that are collectively referred to as “Payment Requests”.

A Payment Request (PR) is submitted by a GC or SubContractor to the Owner/Developer and serves as an invoice that identifies the work completed to date and an Amount Due, so that payment can be rendered. Many companies within the Construction industry continue to rely on spreadsheets, manual calculations, and/or hand-drafted paperwork to create these PRs. This approach is tedious and prone to human error.

To ensure the billing info within a PR is consistent for the duration of the project, the GC will work with each SubContractor to define a Schedule of Values (SoV). The purpose of the SoV is to provide a consistent set of numeration, wording, and mathematical foundation for the Payment Request Applications that will be submitted once the project begins. To be more specific, the SoV contains a list of line items that describe the work to be performed and each line item will be assigned a monetary value. The sum of these values form the basis of the SubContractor's total contract amount for the project. The sum of these values for each SubContractor, combined with the remaining balance for the General Contractor, form the basis of the total contract amount for the project.

During the lifecycle of the project, the GC will require each SubContractor to submit a PR that includes the information from the SoV, along with a monetary value or percentage that represents the work that the SubContractor has performed to date for a specific billing period. For example, the SubContractor's SoV may contain a line item for “Excavation” to identify work to be done; therefore, the SubContractor will submit a PR with an SoV that includes this line item along with a numeric value to indicate how much of the work has been completed. The sum of the numeric values for the work completed form the basis of the Amount Due for that particular PR.

When submitting the PR, the SubContractor may also specify a monetary or percentage value for Stored Materials, which enables the GC and/or SubContractor to be eligible for paid for materials that were purchased for the project, but that have not yet been installed or otherwise used on the project. The value noted for the Stored Materials is used to indicate a value for materials that were purchased during (or prior to) the billing period that are intended to be used for the completion of the project. In some cases, these materials will be physically located on the jobsite so that they are ready to be used when needed. However, in special circumstances, these materials may be kept off-site, in a secured warehouse, or in some other secure location to prevent theft, damage, or other misuse.

When submitting the PR, the SubContractor may also specify a monetary or percentage value for Change Orders, which enables the GC and/or SubContractor to be eligible for paid work performed for the project that was not part of the original plan and was therefore not included in the original SoV.

It is important to note that once a GC and/or SubContractor are selected for a project, it will finalize a contract with the Owner/Developer that outlines what is expected regarding timeframes, the project's contract amount, expectations for source materials, and other details important for that particular GC or SubContractor. The contract document will also define the retainage withholding rules for the project. These retainage rules are used to define the amount of money that the Owner/Developer will withhold from payment until the GC or SubContractor reaches pre-defined milestones that are defined with the retainage rules. The rules which may be flat or may be tiered (ie, withheld at different percentage levels) and may have different percentage values applied for Work Progress and Stored Materials. This money is withheld to ensure the SubContractor finishes the work for the project and may be released in incremental phases or may be withheld until the project itself is fully completed.

For example, for Work Progress Retainage, an Owner/Developer may withhold retainage based on the following rules:

Rule #1) withhold 10% of the SubContractors earnings until the SubContractor has completed 50% of the project;

Rule #2) withhold 5% until the SubContractor has completed 75% of the project;

Rule #3) withhold 2.5% until the SubContractor has completed 90% of the project, and so on.

Further, the Owner/Developer may or may not apply different Retainage Rules for Stored Materials, which would be expressed the following rules:

Rule #1) withhold 10% of the SubContractors earnings until Stored Materials reach $50,000;

Rule #2) withhold 5% until Stored Materials reach $100,000;

Rule #3) withhold 2.5% until Stored Materials reach $150,000; and so on.

It is mathematically possible for a SubContractor to have money withheld at more than one percentage level within a specific billing period, if they cross from one threshold to the next during one billing period.

It is important to note that PRs may differ from conventional invoices: A conventional invoice typically represents a financial statement for a specific billing period whereas PRs contain financial statements for the current and previous billing periods. Unlike a conventional invoice, the information within a PR for the current billing period must be updated when changes occur in any previous billing period, even if there were no changes to the Work Progress, Stored Materials, or Change Orders for the current billing period.

When a SubContractor is eligible to submit their first billing for the project, they will begin the process of completing the Payment Request Application, then submit it to the GC for review and approval of the Amount Due. The GC will receive and approve the PRs from all of the SubContractors who are actively working on the project, so that he may combine the PR data from each SubContractor, to create a consolidated PR for the Owner/Developer for the billing period. This consolidated PR is referred to as a “Merged Billing” and is described further below.

When creating a PR, the process typically requires the GC or SubContractor's personnel on the jobsite (typically a Superintendent and/or a Project Manager) to provide personnel in the back office (typically an Accounting Clerk or Billing Specialist) with an estimate for the percentage of work that will they think will be completed by the end of the billing period for each line item in the SoV. The personnel will also require an estimate related to Stored Materials and/or Change Orders, if needed. It is important to note that the estimates originally provided by the SubContractor's jobsite personnel to its back office may change before the initial draft of the PR Application will be ready for submittal to the GC.

The PR creation process typically starts before the billing period has ended. For example, if the billing period covers the month of January, then the initial estimate will often be submitted from the Sub Contractor's jobsite to the back office on (or around) the 20^{th} of the month, which means the SubContractor has only actually completed about two-thirds of the work they intend to perform for a monthly billing period. Multiple factors may render this estimate to be inaccurate, ranging from simple delays in project progress, disruptions in working conditions, delays from weather patterns, delays due to materials availability, or other delays that are within or beyond the control of the GC or Sub Contractor.

Most importantly, the estimate is provided early to ensure that the back office personnel have time to perform all of the manual efforts related to reviewing, updating, and finalizing a PR Application. For example, the back office personnel will need time to perform reviews, calculate progress percentages, calculate retainage, collect information related to Stored Materials, and perform other line item edits or mathematical adjustments.

Once the back office has received the initial information regarding the project's progress from the jobsite, the data will usually be manually entered into some type of document or spreadsheet that is maintained by the SubContractor. (In some cases, a GC may provide the SubContractor with a specific spreadsheet format that is to be used; However, each SubContractor is responsible for creating and maintaining their own documentation and ensuring the mathematical formulas are calculating the elements of the PR correctly.)

Once the SubContractor's back office personnel has entered the initial work progress estimates for the PR, the personnel will perform a series of steps to ensure the mathematical formulas are being calculated correctly. This can be a tedious task that requires business knowledge and a detailed, intrinsic understanding of mathematical concepts such as linear algebraic equations. Once the math in the PR has been calculated, it will need to be re-calculated if changes were made to a previous PR while the current PR was being drafted.

Ultimately, the objective is to use the Payment Request to identify an Amount Due for a specific billing period, so that the Owner/Developer knows how much to pay the General Contractor, who will then issue payment(s) to the SubContractors.

Generally speaking, during the course of the project, both the GC and SubContractors are responsible for submitting Lien Waivers for the payments received. In most cases, the SubContractor is also responsible for collecting Lien Waivers that are owed by Sub-Tiers or Third-party Vendors for the payments that were issued to them. (A Lien Waiver is a document from a General Contractor, Subcontractor, materials supplier, equipment lessor or other party to the Owner/Developer stating that they have received payment and waive any future lien-rights to the property (of the Owner) for the amount that was paid.)

For most projects, the SubContractor will send a copy of the Lien Waivers documents to the General Contractor, who will review and approve them, before the documents are sent to the Owner/Developer. The Owner/Developer may accept digital soft copies of signed Lien Waivers, or may require the signed hard copy documents.

In some cases, the Owner/Developer may require Zero Lien Waivers (Zero LWs). A Zero LW is similar to “standard” Lien Waivers, with one key difference: A Zero LW is not based on a payment that was received; but rather, a Zero LW is used to verify that a payment was not received because no payment was owed. Thus, a Zero Lien Waiver is typically categorized as a Zero Lien Waiver, rather than one of the four “standard” Lien Waiver types of Conditional Partial Payment, Conditional Final Payment, Unconditional Partial Payment, or Unconditional Final Payment.

An Owner/Developer will require a Zero Lien Waiver to ensure they have a written Lien Release from everyone on the project, acknowledging that even though they did not receive any money during a given time period, they were not expecting any either, so therefore a Zero Lien Waiver is provided to acknowledge that the Owner is in the free and clear.

If an Owner/Developer requires Zero Lien Waivers and issues a payment to a GC, the GC will pay the relevant SubContractors and if there are SubContractors who did not receive payment, the GC will notify them as needed to provide a Zero LW.

Others have invented billing management software for the Construction industry. However, these programs typically require billing information to be input based on manual data entry or require certain info to be maintained separately or in external spreadsheets to function properly. There currently is no efficient way in which the various companies can create, update, review, modify, PR information online while maintaining mathematical accuracy while also ensuring changes to previous PRs will automatically update and/or synchronize with the current PR's info.

The present invention overcomes these problems by enabling the PR info to be updated online while simultaneously ensuring mathematically calculations are automatically updated and synced across multiple billing periods.

### BRIEF SUMMARY OF INVENTION

The present invention is a software application that provides five core functions, as defined below.

The invention provides Users with the ability to store, manage, and process financial and payment information about their Construction projects by using an integrated software and database platform that can be accessed over the Internet or other network-based platform.

The invention enables a GC or SubContractor User to create, manage, and update a SoV online and to create, manage, update, and submit Payment Requests (PR) online without requiring the use of a separate spreadsheet(s) or other file(s) to perform calculations that are to be uploaded into the system, etc. This approach reduces the time and complexity that is commonly required to establish a common invoicing format; reduces the likelihood of calculation errors; and ensures consistent accuracy of the billing and invoice data sent from the SubContractor to the GC and Owner/Developer.

Another aspect of the invention provides the GC or SubContractor Users with the ability to create, review, modify, and update PRs online, without needing to re-key data entered into previously created PRs. This unique approach reduces the time and complexity that is commonly required to ensure accuracy for the work performed, materials stored, and/or change orders.

Another aspect of the invention enables GC Users to combine all of the PRs from the SubContractors working on the project to form a Merged Billing, which can then be sent to an Owner/Developer for further review, modification, and payment approval. This unique approach reduces the time and complexity that is commonly required to submit billing and invoice data to the Owner/Developer.

Another aspect of the invention includes a method that allows the PRs and Merged Billings to be connected, to ensure that chronological, serial, and sequential mathematical formulas can be correctly applied to support business, financial, and project requirements. This unique approach ensures that when a User is working on a PR, if any changes are made to a previously created PR and/or Merged Billing, those changes will automatically update previous or subsequent PRs and/or Merged Billings, as required.

Another aspect of the invention includes a method that enables a User to maintain a log of Payments and track how these payments are disbursed across one or more PRs or to Sub-Tiers or Vendors. The system includes methods to track the status of Lien Waivers for payments or non-payments.

Others have invented billing management software for the Construction industry, but the present invention is superior because:
1. It enables Users to create, update, and modify their Schedule of Values (SoV) online.
2. It enables Users to create, update, and modify their Payment Request (PR) online.
3. It enables Users to create, update, and modify a Merged Billing (MB) online.
4. It enables PRs (and Merged Billings) to be linked together, rather than be managed as separate files.
5. It is not cumbersome.
6. It alleviates the need for the Users to perform manual calculations or write complex mathematical formulas.
7. It includes a method to track billing information through submission, review, and approval workflows
8. It includes a method to automatically calculate and distribute flat, tiered, and/or variable retainage requirements by line item.
9. It includes a method to support requirements for sequential billing (ie, the system generates the continuous numbering that is required for each project's unique billing sequence).
10. It includes a method to perform the mathematical calculations needed for serialized and progressive billing (ie, the system ensures the accuracy and continuity of billing data that must be created, updated, and synchronized (synced) from one billing period to the next, throughout the entirety of the project's billing lifecycle).
11. It includes a method for Change Orders to be added to PRs (and Merged Billings) to ensure billing information can be calculated and automatically, progressively tracked throughout the project's billing lifecycle.
12. It includes a method for the SubContractor to create PRs even if the GC is not also a Customer using the system.

### BRIEF DESCRIPTION OF THE DRAWINGS

FIG. 1 is a diagram of the logical architecture of the system according to one embodiment of the invention.

FIG. 2 is a diagram of the physical architecture of the system according to one embodiment of the invention.

FIG. 3 is a workflow diagram of the corporate setup process.

FIG. 4 is an illustration of the Corporate Management screen.

FIG. 5 is an illustration of the User Management screen.

FIG. 6 is a workflow diagram of the Project Setup Process.

FIG. 7 is an illustration of the Project Setup Screen.

FIG. 8 is a workflow diagram of the Payment Request and Merged Billing Process.

FIG. 9 is a workflow diagram of the Payment Request Status updates.

FIG. 10 is a workflow diagram of the Change Order Process.

FIG. 11 is an illustration of the Payment Request Worksheet.

FIG. 12 is an illustration of the Merged Billing Payment Request Worksheet.

FIG. 13 is a workflow diagram of the Payment Management Process.

FIG. 14 is a workflow diagram of the SubContractor Lien Waiver Process.

FIG. 15 is a workflow diagram of the Payment Request and Merged Billing Update Process.

FIG. 16 is an illustration of the Disbursements tab on the Payment screen

FIG. 17 is an illustration of the Retainage tab on the Payment screen

FIG. 18 is an illustration of the Sub-Tier Payments tab on the Payment screen

FIG. 19 is an illustration of the Lien Waiver management screen

FIG. 20 is an illustration of the Corporate management screen, where a User can manage Company Contact information

FIG. 21 is an illustration of the Corporate management screen, where a User can manage Company and Division information

FIG. 22 is an illustration of the Corporate management screen, where a User can manage Company Region information

FIG. 23 is an illustration of the Project management screen, where a GC User can manage basic information about a project

FIG. 24 is an illustration of the Contract Financials tab on the Payment Request screen

FIG. 25 is an illustration of the Project Management screen, where a GC User can manage their own retainage rule settings

FIG. 26 is an illustration of a Project Management data entry input method, where a GC User can add a SubContractor to a project

FIG. 27 is an illustration of the Project Management screen, where a GC User can manage the retainage rule settings for a SubContractor

FIG. 28 is an illustration of the Contract Financials tab on the Payment Request Management screen

FIG. 29 is an illustration of the Change Orders tab on the Payment Request Management screen

FIG. 30 is an illustration of a Payment Request data entry input method, where a User add one or more Change Orders to a Payment Request

### DETAILED DESCRIPTION OF THE INVENTION

The invention enables members of the Construction Industry (namely, General Contractors (GC) 4 and SubContractors 5) to gain full control of Payment Requests (PRs), which are documents used for invoicing and billing management, in an online format, so that they may create, modify, submit, review, and approve these documents online, without using external spreadsheets or other files and systems. Further, the invention enables GC to combine the PRs online, to further enable them to establish a “Merged Billing” that can be sent to the Owner/Developer 3 (or their designee) who is responsible for reviewing and approving the PRs so payment can be made. (The Owner/Developer 3 is directly responsible for paying for the work performed towards completion of the construction project). Further, the invention includes unique mathematical formulas and data connections that allows PRs and Merged Billings to be linked together to support continuous, progressive mathematical calculations. And finally, the system enables Users to track payments and the status of Lien Waivers.

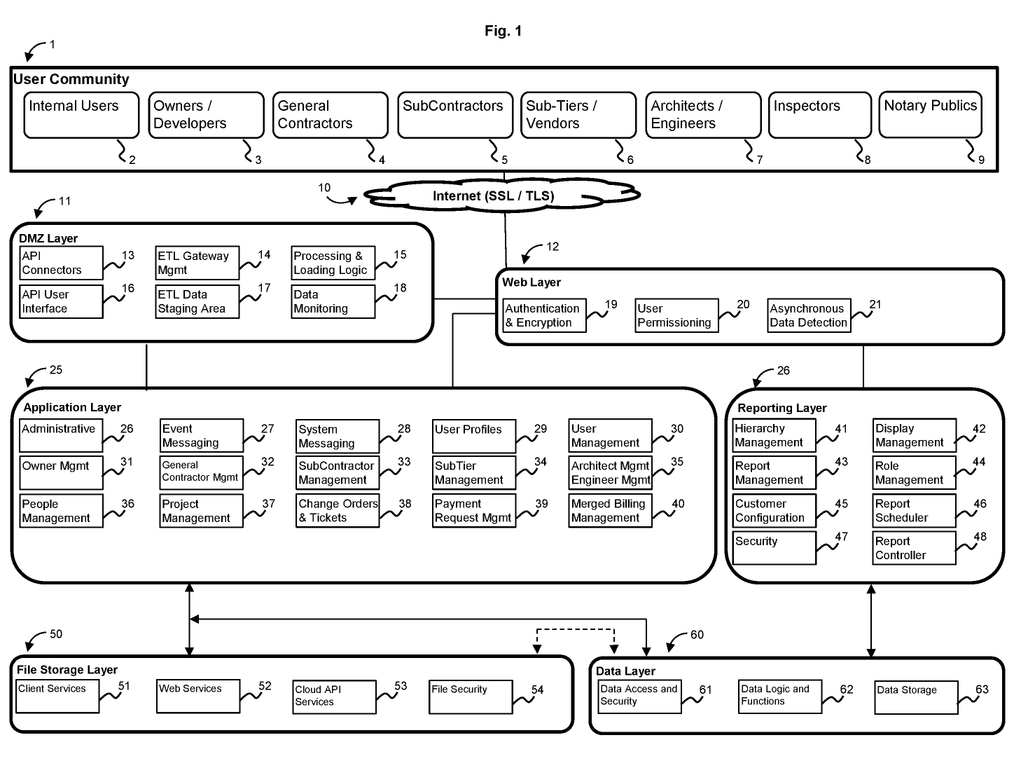

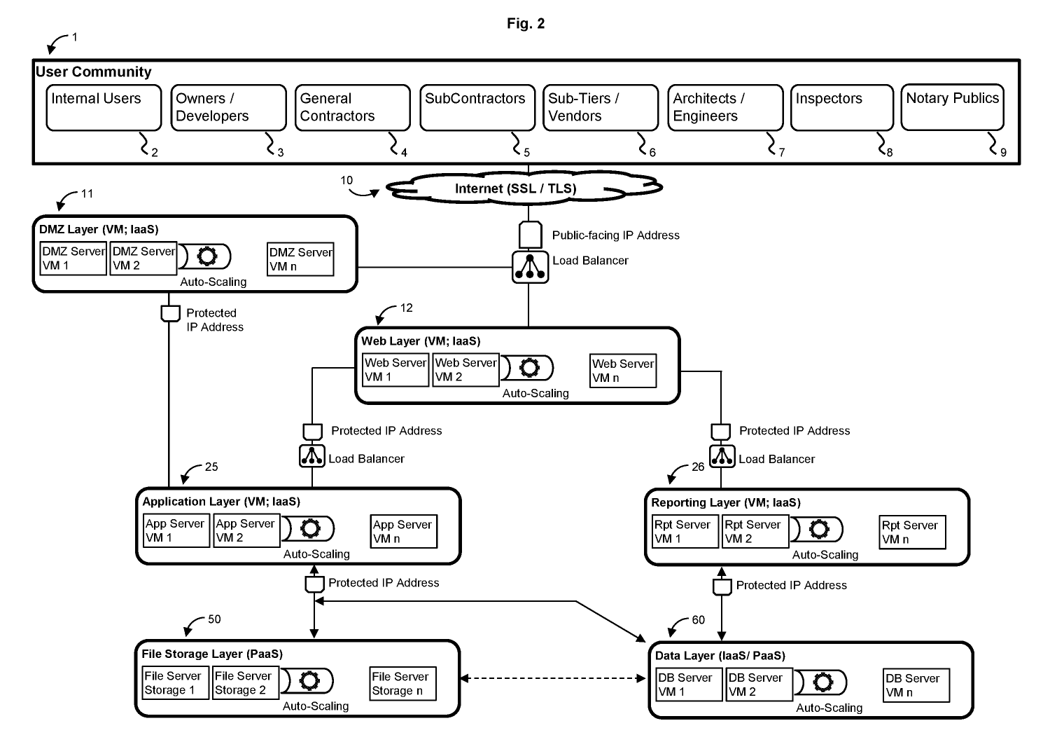

The invention is provided through a network-enabled software application that is accessed by the User Community (FIG. 1) through a computer, laptop, tablet, or other network-connected device. The device enables the user to log in to the software, which is supported by a Technical Architecture (FIG. 2) that enables the User to interact with the software application and the underlying data.

FIG. 1 depicts the User Community, which consists of several distinct entities: Internal Users 2; Owners/Developers 3; General Contractors 4; SubContractors 5; Sub-Tiers and Vendors 6; Architects and Engineers 7; Inspectors 8; and Notary Publics 9. Each entity plays a unique role in a Construction project and is either directly, or indirectly, related to the invoicing, billing, and/or payment management process. Generally speaking, the General Contractor (GC) 4 coordinates with the Owner/Developer 3 and Architect/Engineer 7 to establish a Construction Project. This group will typically coordinate to select the SubContractors 5 who will work on the project, and the SubContractor(s) will then identify their own Sub-Tiers and Vendors 6, Inspectors 8, and Notary Publics 9. (The GC will typically also have their own unique Inspectors 8 and Notary Publics 9.) Inspectors and Notaries may be internal personnel or external contractors or consultants.

FIG. 2 depicts a Technical Architecture that enables the User Community 1 to access the software application by using a Network-connected device. To access the software, the User must first log in through the Web Layer 12, which controls Authentication and Encryption (for application security) 19, User Permissioning 20 (to control who can access what), and Asynchronous Data Detection 21 (to determine who is viewing or modifying info). When the User has successfully authenticated and logged in, they can now interact with the DMZ Layer 11, the Application Layer 25, the Reporting Layer 26, the File Storage Layer 50, and the Data Layer 60, as necessary. (Please note that there are different configuration methods to support the Technical Architecture, such as combining elements together or segmenting the elements in different ways; FIG. 2 identifies one such Technical Architecture.)

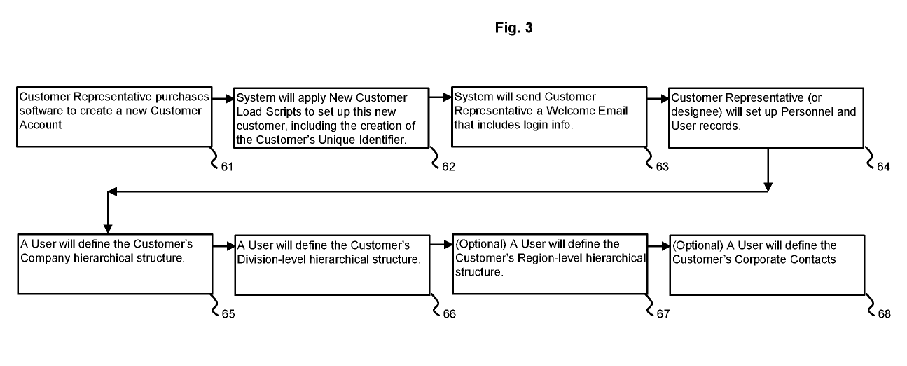

FIG. 3 illustrates how a Customer is first permitted to access the software, whereby a Customer Account must first be created. A Customer Account enables the system to logically segment the User Community 1 and is one method of controlling what a User can see and do while using the software. To create a Customer Account, someone within the User Community 1 will purchase a license for the software 61, which causes the system to initiate Data Load Scripts and Functions 62 that will populate the database with data needed to support the new Customer Account, including the creation of the a globally unique identifier (GUID) for that Customer. When the new Customer's data is loaded, the system will send the Customer Representative a “Welcome Email” with instructions on how to log into the software. The Customer Representative (or their designee) will then create Personnel and User records 64 so that other staff members can access the system over the Internet 10 and perform tasks to store data 63.

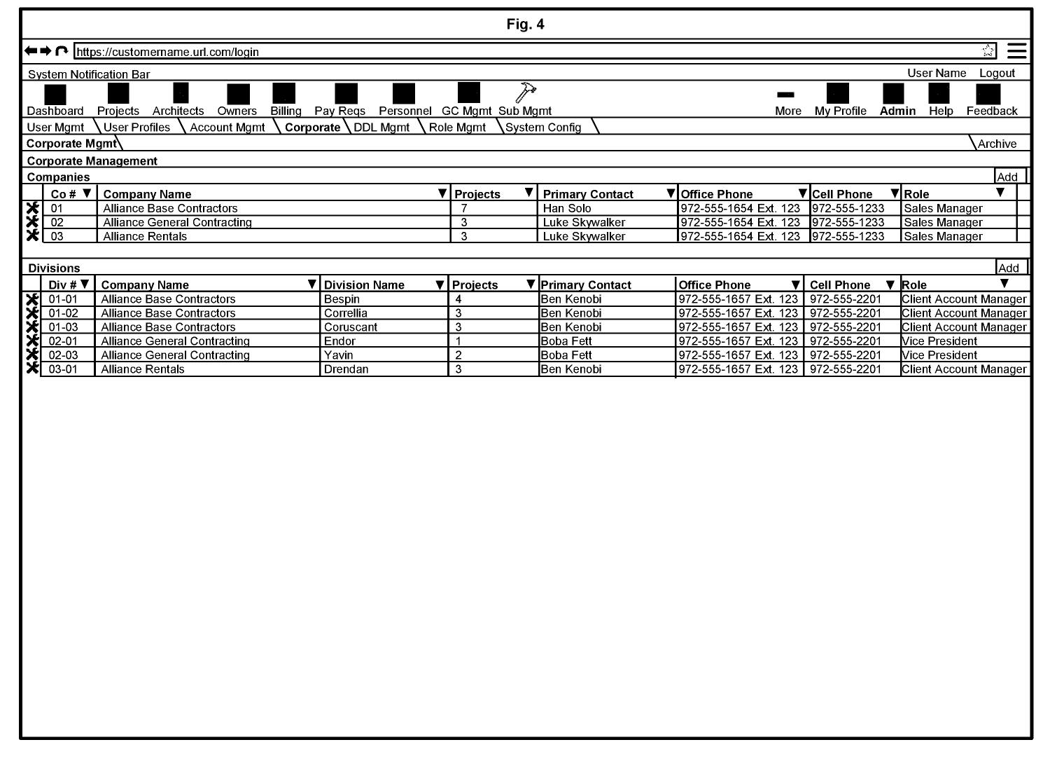

FIG. 4 illustrates the Customer's Corporate Management Screen, where the Customer's Users are responsible for identifying their Corporate Hierarchical structure, which consists of Companies 65 and Divisions 66. The User can further define their Corporate Hierarchy using Regions 67 and Corporate Contacts 68. The Customer is in full control of their Corporate Hierarchy and can independently add, edit, or remove Company, Division, or Region records as necessary, to better define how these companies are related to the projects being worked on.

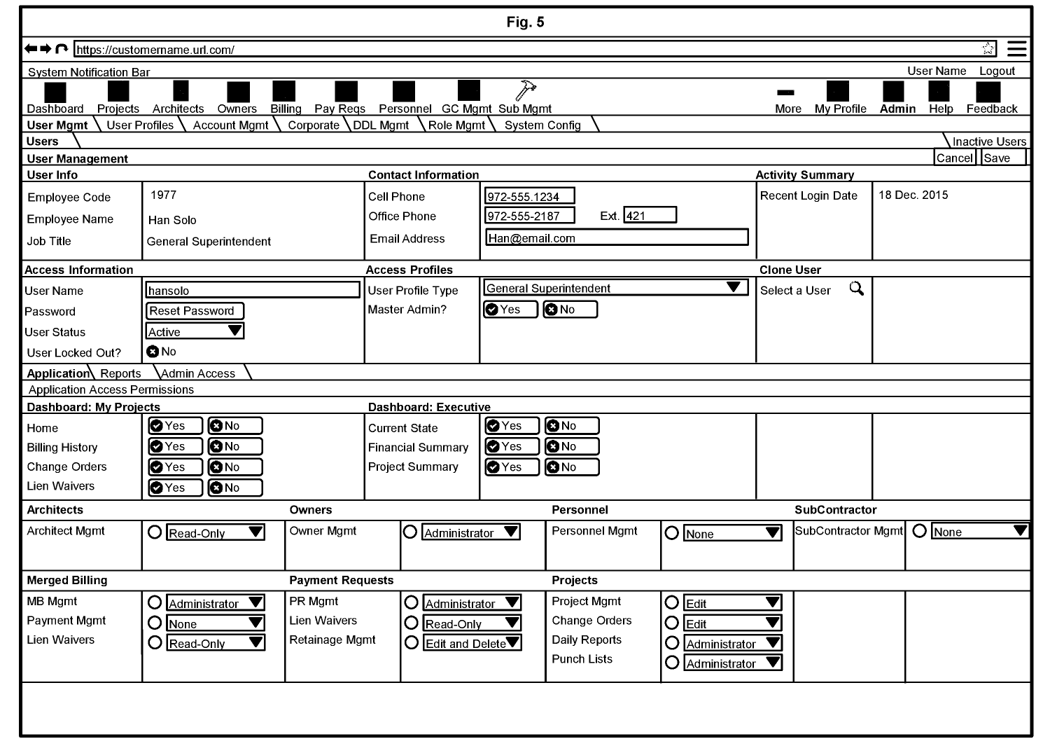

FIG. 5 illustrates the User Management screen, which enables the Customer to control each User's ability to login and interact with the software. To be more specific, the Customer can independently control which Application areas that each User can access, which privileges the User will have, which Reports the User can open, and whether the User has Administrative Access privileges. For example, the User Management page is used to control whether a User can create, edit, or view a PR (meaning that User's permission setting is “Administrator”, “Edit”, or “Read-Only”, respectively). If a User should not be allowed to access an area of the application, then their permission setting is set to “None”.

The GC and SubContractor Users will require access to multiple areas of the software to set up the baseline data needed to manage projects and the billing process, including access to Administrative areas 26; System Messaging 28; User Profiles 29; User Management 30; Owner Mgmt 31; General Contractor Mgmt 32; SubContractor Management 33; SubTier Management 34; Architect/Engineer Management 35; People Management 36; Project Management 37; Change Orders and Tickets 38; Payment Request Management 39; and Merged Billing Management 40. (Each User is in control of their own preferences for Event Messaging 27.)

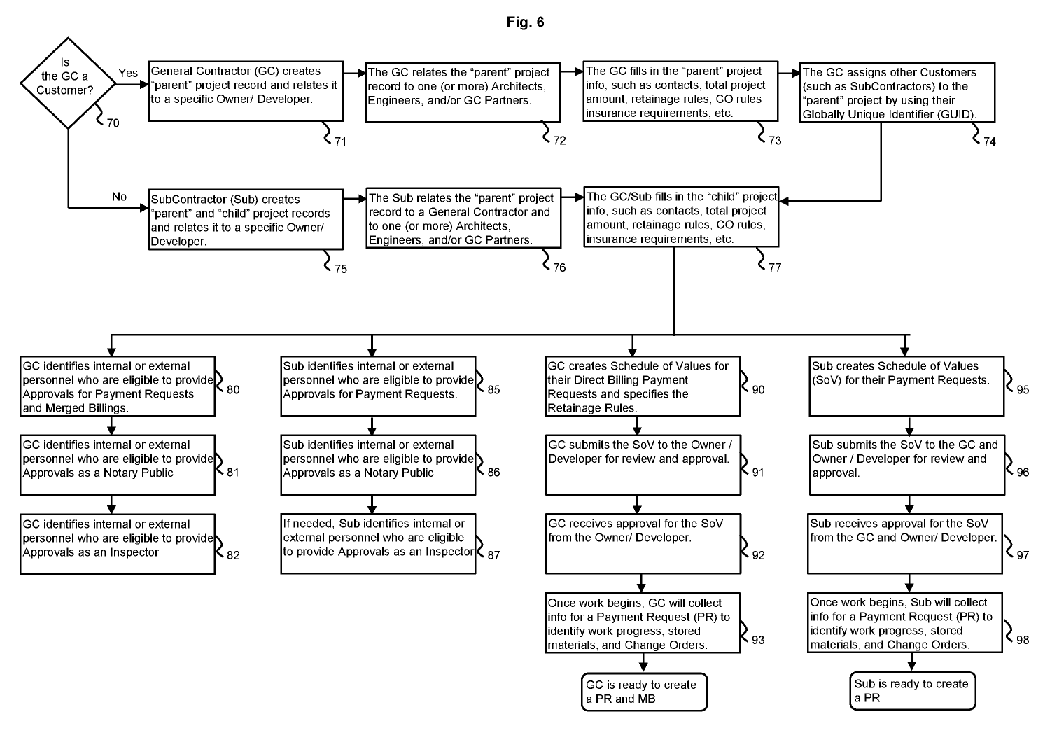

FIG. 6 illustrates the workflow that is used to create a project record, which must be completed before the billing process can begin. This process varies slightly depending on whether the GC is a Customer or not 70. If the GC is a Customer, he will create the “parent” project record and assign the Owner/Developer 71, Architects, Engineers, and/or GC Partners 72. The GC can then fill in other important project information 73, such as contacts, the total project amount, the retainage rule settings for each SubContractor (as well the GC itself, if needed), and the insurance standards for the project. The GC will also specify whether or not retainage will be withheld for the Work Progress or Stored Materials that are related to Change Orders.

Once the baseline project info has been created (FIG. 6.), the GC will use the GUID of the SubContractor customer 74 to assign other Customers to the project, which will automatically create the “child” project records that will be used in the billing process.

If the GC is not a Customer, then the SubContractor will create both the “parent” and “child” project records 75 and will identify the GC, Architects, Engineers, and GC Partners on the project 76. The SubContractor will fill in other important project information 76, such as GC, Architect, and Engineering contacts, as well as the project amount, the retainage rule settings, and will specify whether or not retainage will be withheld for the Work Progress or Stored Materials that are related to Change Orders 77.

Once the “parent” and “child” project records have been created (FIG. 6), the GC or the SubContractor will provide other details related to the project that may be needed for the billing process 77, including: the information about the project amount (the contractual amount of money the Owner/Developer 3 agrees to pay for the work to be performed); the project contacts (to identify the Project Lead and Project Approvers who will receive notifications throughout the billing process); and the retainage rules (to identify the percentage of money that will be withheld in payments for PR that is submitted).

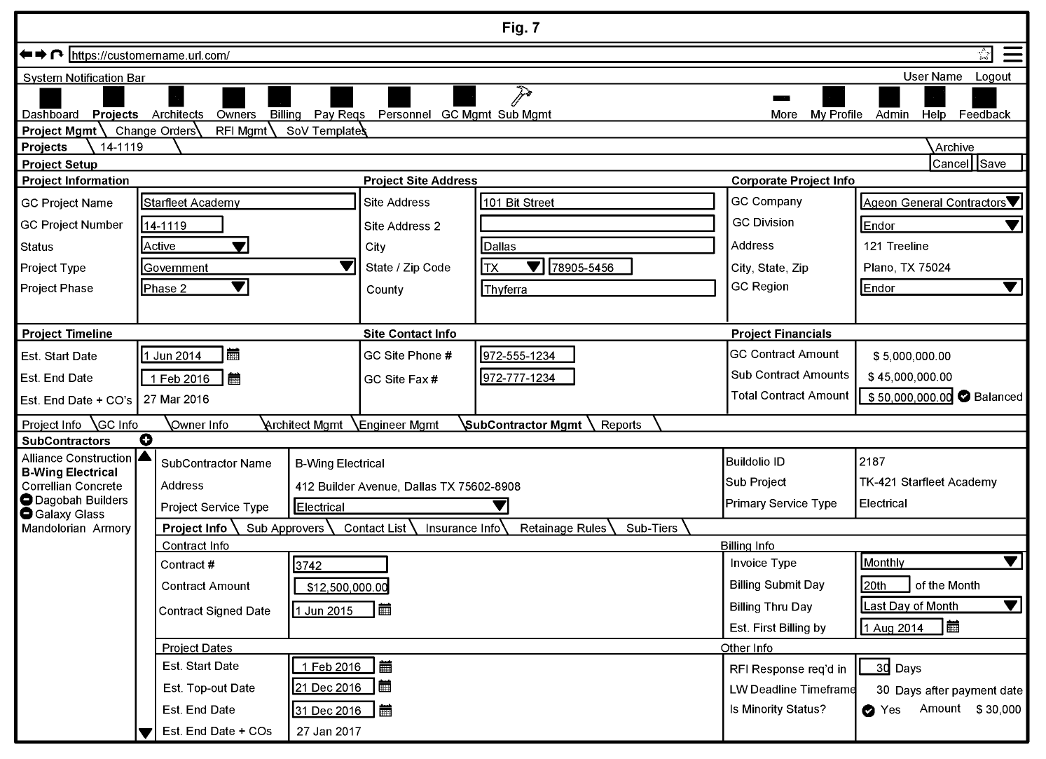

FIG. 7 depicts the project management screen with SubContractors assigned to the project. It is important to note that the GC and the SubContractor will manage their project information independently while using the Project Management screen FIG. 7. However, if the GC created the “parent” project record 71, then the SubContractor will be restricted from seeing and/or editing certain information on the page. For example, the SubContractor would not be able to modify their contract amount, or insurance standards, or the retainage settings on the Project screen FIG. 7. A SubContractor is restricted from seeing the information of other Sub Contractors.

Continuing with project set-up process (FIG. 6), the GC will identify the internal or external personnel who are allowed to log into the system and provide approvals to billing information, including the personnel who are PR and Merged Billing Approvers 80; Notary Public Approvers 81; and/or Inspector Approvers 82. The SubContractor will be responsible for identifying their own approvers, including Payment Request Approvers 85; Notary Public Approvers 86; and/or Inspector Approvers 87.

The GC will use the invention to create a Schedule of Values (SoV) for themselves online 90, which will be submitted to the Owner/Developer for review and approval 91. Once the Owner approves of the SoV 92, the GC can begin preparing to submit their first PR, which consists of someone on the jobsite keeping a record of the work being performed during a specific billing cycle 93.

The SubContractor will similarly use the invention to create an SoV online 95, which will be submitted to the GC and Owner/Developer for review and approval 96. Once the Owner provides the approval 97, the Sub can begin preparing to submit their first Payment Request 98, which is similar to the GC's own process 93 above.

An SoV is used as the foundation for the billing management process. The SoV contains a list of the billing items that will be included in a Payment Request and subsequent Merged Billing, including work items that will be included, the order they are displayed in, and the financial value of each task or work item that will be completed during the course of the project. The invention includes methods that enable a User to create and modify this information online, before or during the project. The invention further includes methods that ensure that once the billing process has begun, the mathematical information within the PR stays in sync with the SoV and that the mathematical totals stay balanced with the project's contract amount. (These methods are defined further below.)

To speed up the review and approval process for an SoV, the invention provides methods that allow the user to create the SoV online or to import the data from an external file using the DMZ Layer 11, as shown in FIG. 1.

If a User chooses to import data into the system, they will rely on the Application Program Interface (API) Connectors 13 and API User Interface 16 to bring the data into the system. Access to the API is controlled via Extract, Transform, and Load (ETL) Gateway Management 14, where the Processing and Loading Logic 15 can be used to extract the data from the source file and load it into an ETL Staging Area 17. Once loaded, the data is monitored 18 to ensure it was formatted and loaded correctly. If it was not, the User will receive an error message. If the data was extracted, transformed, and loaded successfully, the system will automatically load the imported data to the Data Layer 60. (The Data Layer is used to provide Data Access and Security 61; to control Data Logic and Functions 62; and for general Data Storage 63.)

At this point, the SoV has been created and the GC and the SubContractor are both ready to use the invention to begin the billing process and create a PR online 100.

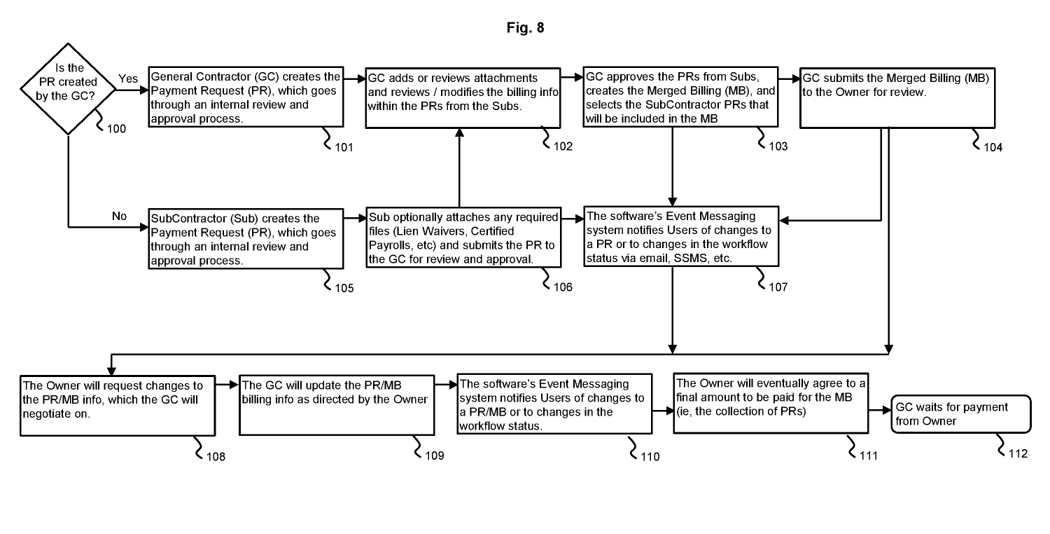

FIG. 8 depicts the process used to create a PR, whereby the GC and the SubContractor will collect internal info about their own work that was completed as well as the value of any materials that were stored during that billing cycle. This information forms the basis for their PR, which will be used to identify the amount that they will be paid by the Owner/Developer for that billing cycle. (A billing cycle typically runs on a monthly basis, but could run on some other frequency, such as ad-hoc, daily, weekly, or twice-monthly.)

When a GC creates a PR, it will undergo an internal review and approval process 101 so it can receive an approval by the personnel selected for PR Approvals (FIG. 6; 80) and Notary Public Approvals (FIG. 6; 81). The GC User can then optionally attach files and make other modifications, as necessary 102.

Continuing with PR process (FIG. 8), when a SubContractor creates a PR, it will also undergo an internal review and approval process 105 so it can receive an approval by the SubContractor's personnel selected for PR Approvals 85 and Notary Public Approvals 86. The SubContractor User can optionally attach files and make other modifications, as necessary 106 before submitting the PR to the GC for further review and approval 106.

It is important to note that the invention enables the SubContractor to submit the PR to the GC in an online format; The SubContractor does not have to export the data and/or create a separate file that will be sent to the GC. (The invention does allow the user to export the data and create a separate file in multiple file formats if desired, by using the Reporting layer 26, but this is not a requirement for the invention to function properly. For example, the user can export data to file formats such as Adobe PDF, Microsoft Excel, Microsoft Word, and/or XML.)

Continuing with the PR process (FIG. 8), when a GC receives a PR from a SubContractor 102, the PR will undergo an internal review and approval process so it can receive an approval by the GC's personnel who were previously selected for PR Approvals 80 and Inspector Approvals 83. The GC User can optionally attach files and make other modifications, as necessary 102. Eventually, the GC will approve the PRs submitted from the Subs and create a Merged Billing 103, which will then be submitted to the Owner 104. (The Merged Billing enables a GC to combine his PR with the PRs from the Subs, which further enables the GC User to make changes to PRs either individually (one by one) or collectively (while viewing them together) from within the Merged Billing)

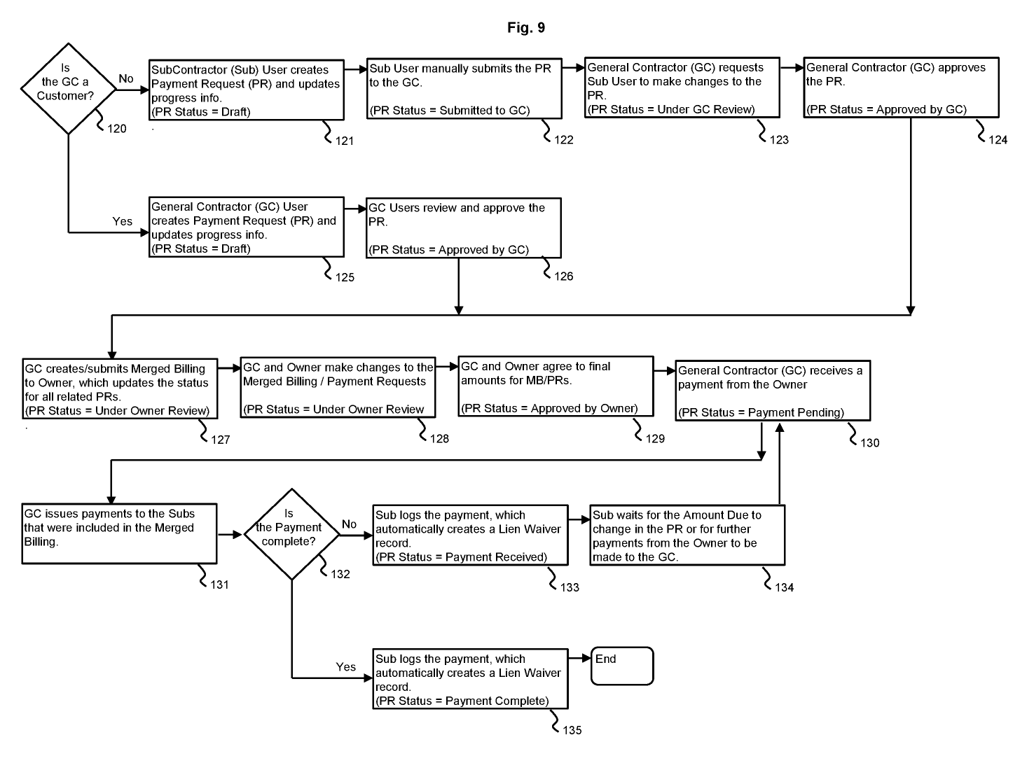

Continuing with the PR process (FIG. 8), during the PR review process 102, the invention's Event Messaging system 107 can automatically notify Users of changes to a PR or to changes in the workflow status (which is defined in FIG. 9, below) via email or short messaging service (SMS), according to that User's individual messaging preferences, should they choose to receive any messages at all.

Once the Merged Billing (ie, the collection of PRs) has been submitted to the Owner/Developer, they may request that the GC make changes, typically to reduce the total Amount Due. The GC will negotiate 108 these changes with the Owner, and use the invention's online data management methods to update the each PR within the Merged Billing as necessary 109, in accordance with the Owner/Developer's wishes. The invention's Event Messaging system 110 will continue to notify Users as changes are made, based on each User's unique messaging preferences. Eventually, the Owner will agree to pay a specific amount for each of the PRs. The total payment that is issued will correspond with the Amount Due as specified within the Merged Billing 111.

FIG. 9 depicts the process used for defining the status of PRs, which works slightly differently depending on whether the GC is a Customer or not. This workflow process enables the invention to systematically track the status of a PR from its initial creation through the final payment process. A PR starts with a status of “Draft” for both the SubContractor 121 and the GC 125, then the workflow diverges slightly based on the GC's status as a Customer. If they are a Customer, when the SubContractor sends their PR to the GC, the status will be set to “Submitted to GC” 122 until the GC begins making changes, at which point the PR's status will automatically change to “Under GC Review” 123. Eventually, the GC will finish making changes and will mark the PR as “Approved by GC” 124. Conversely, a GC's PR typically moves from a “Draft” 125 through their own internal review process, where its status will be set to “Approved by GC” 126. If the GC is not a Customer, the SubContractor will be responsible for updating the status of their PR as it moves through the GC and Owner's review and approval process.

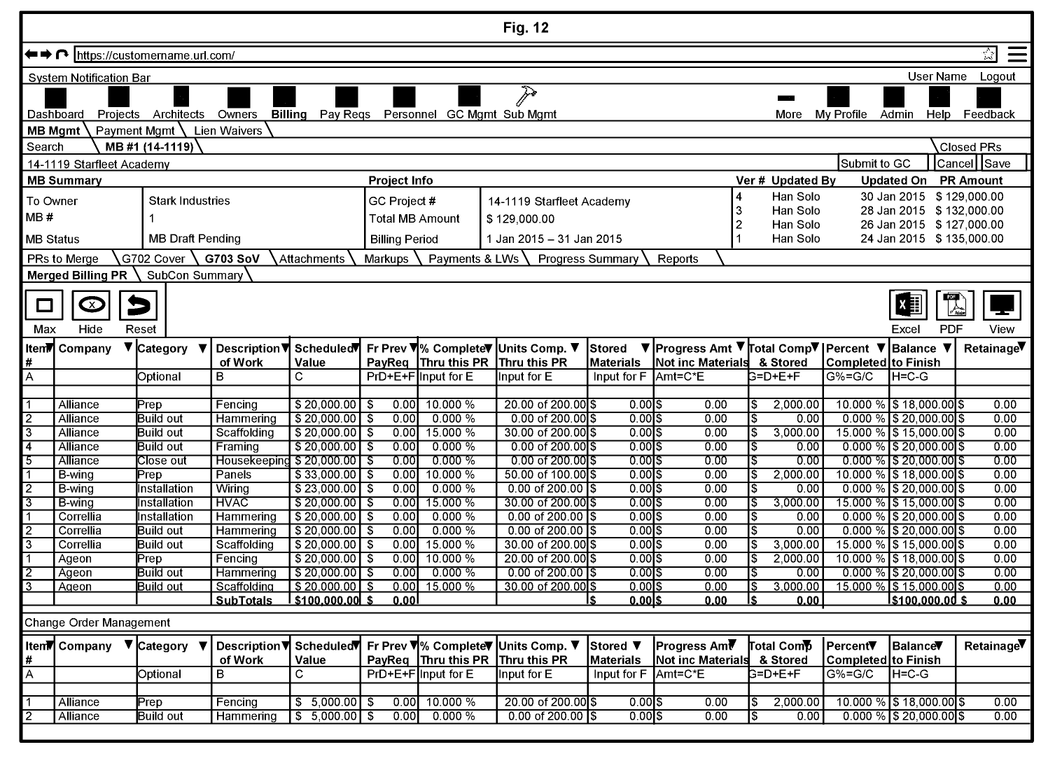

When the PRs are approved, the GC can create the Merged Billing (shown in FIG. 12), which combines the billing information for each SubContractor on the project who has submitted PRs for the current billing period or any previous billing period.

The GC can now submit the Merged Billing and PR information to the Owner/Developer 3, which will then automatically update the status for all PRs to “Under Owner Review” 127. When the GC begins making changes to the Merged Billing or a specific PR, each PR's status will remain as “Under Owner Review” 128 until a final amount is agreed upon with the Owner/Developer, where the status will then be set to “Approved by Owner” 129.

Continuing with PR status update process (FIG. 9), once all of the PRs have been approved by the Owner/Developer 3, the GC will receive payment from the Owner 130. The GC will then issue payments to the SubContractors 131. At this step, the payment amount should be equal to the Amount Due, as specified in the Payment Request 132.

If the payment received does not equal the Amount Due, the SubContractor will log the partial payment, which will automatically create a Lien Waiver record and sets the PR status to “Payment Received” 133. (The SubContractor will typically be required to provide a Lien Waiver to acknowledge the payment that was received.) The SubContractor will then either wait for further changes to their PR to alter the Amount Due so that the payment is complete or they will wait for further payment(s) to be made 134. The SubContractor will log each payment until the amount paid is equal to the Amount Due, which will set the PR status to “Payment Complete” 135.

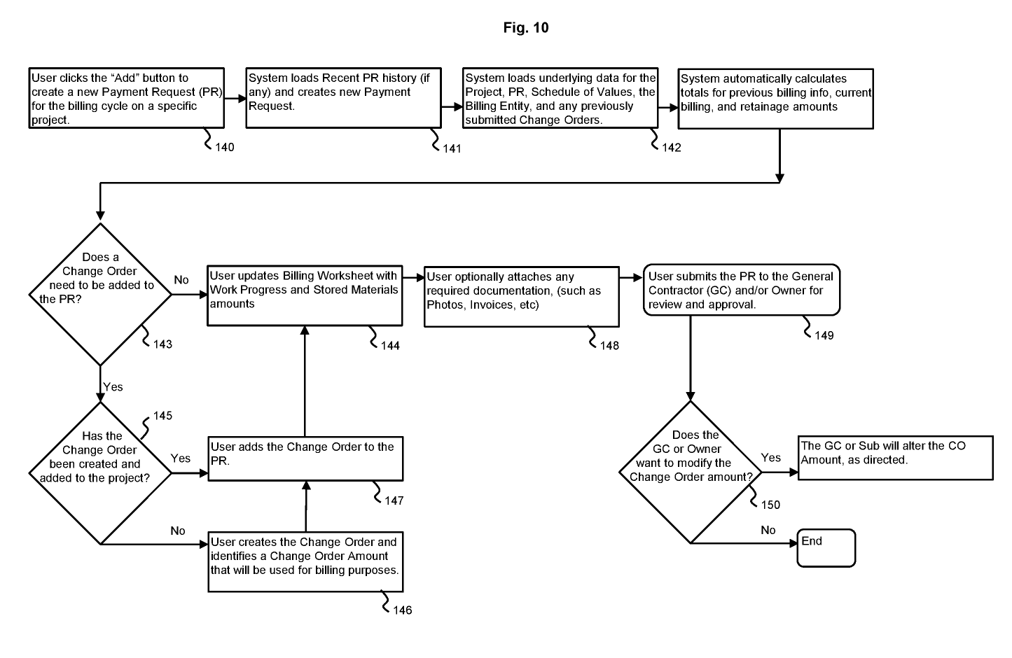

FIG. 10 depicts the process used to add a Change Order to a PR. A Change Order is used to identify additional work that falls outside the original scope of the project (as defined in the Contract Documents) and may be identified by the Owner/Developer 3; General Contractor 4; SubContractor 5; Architect/Engineer 7; and/or Inspector 8. The Change Order will define the scope of that work and assign a monetary value to that additional work.

To add a Change Order to a Payment Request 140, the User will first create the PR (as previously described in FIG. 8). The invention will automatically load the Payment Request History (if there were any previous Payment Requests) 141 and will also load the necessary information for the Project, the current billing period, the PR, the SoV, the Billing Entity, and any previously submitted Change Orders 142. Once this info is loaded, the system will perform the calculations that are necessary to determine the amounts and percentages for previous billing info, current billing info, and retainage. (The logic for these calculations is defined below.)

At this time, the User (FIG. 10) can determine if the PR needs any new Change Orders that were not submitted with previous Payment Requests 143. If the PR does not need a Change Order, the User would continue updating the billing worksheet on the PR to record any Work Progress or Stored Materials 144.)

If the User (FIG. 10) determines a new Change Order does need to be added to the PR, the User must then determine if the Change Order itself has previously been added to the system or not 145 (i.e., the User must determine whether or not someone has previously created the info for the Change Order and added it to the Database shown in FIG. 2). If the Change Order has previously been created, then the User adds the Change Order to the Payment Request 147 and continues modifying the PR as needed 144. If the Change Order has not previously been created, then the User must first create the Change Order 146 so it can be added to the PR 147. (The User can optionally 148 attach files to the PR to provide supporting documentation for the Change Order, such as Photos, Invoices, etc.) Once a Change Order has been added to a PR, it will appear in the Billing Worksheet (FIG. 12) along with all other Schedule of Value work items, so that the User can review each line item and specify work progress or a stored materials amount. (Once a PR has been submitted to the GC 149, in some cases the GC or Owner may request the Change Order amount to be modified 150.)

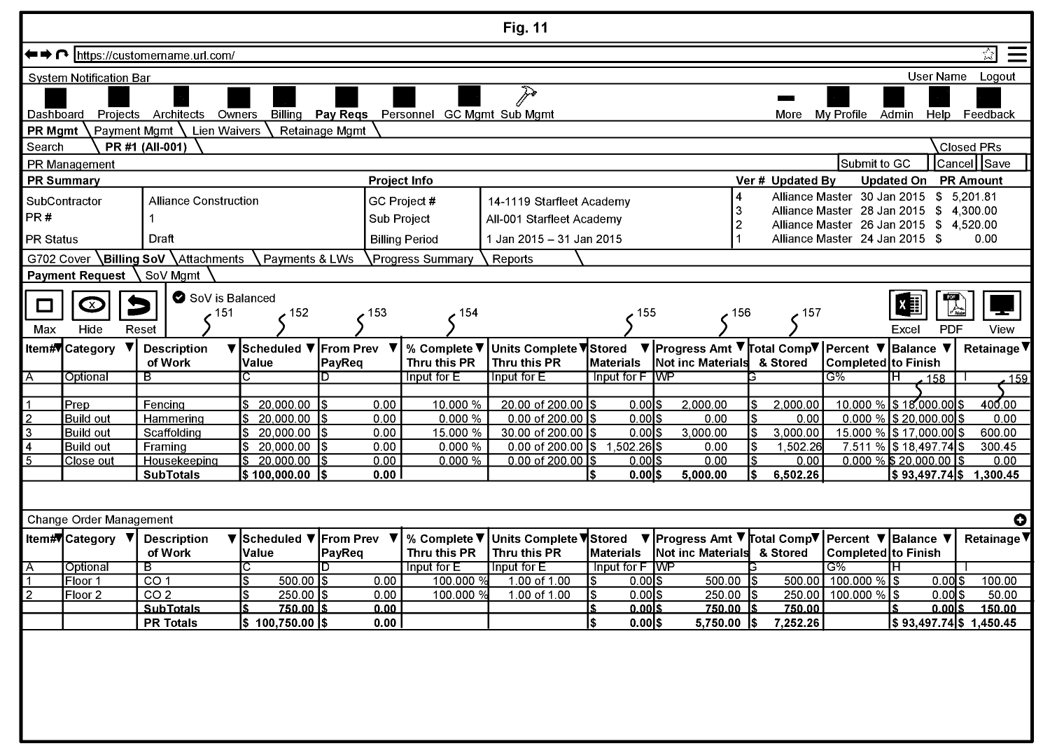

FIG. 11 depicts the Billing Worksheet for a PR, which can be created by a GC or Sub Contractor User (as defined in FIG. 8.). The Payment Request Billing Worksheet FIG. 11 enables the User to record the percentage of Work Progress that has been completed to date; the Units that have been completed to date; and/or the financial value of any materials being stored for the project.

Once the PR has been created, the User can update or modify the billing info, as needed. To update the billing information, the User must first locate a specific line item from the SoV, by using the Item number, the optional Category, and/or the Description of Work 151, so that the User can then input a value for Percent Complete 154 (or Units Complete) through this PR and/or insert a value for Stored Materials 155 to record the most current progress information for a specific billing period.

When the User creates the PR record, the system will create Version 1 of the PR, then automatically populate the information needed to uniquely identify a specific line item within the Schedule of Values, which includes the Item number, the Category, the Description of Work 151, and the Scheduled Value amount 152. The system will also fill in the data for the remaining columns in the worksheet, as defined below.

When the PR is first created, the system populates the Billing Worksheet with project information, such as the company name, project number and name, the billing period, PR Status, and the unique PR number and version number, along with the PR Amount Due. This information helps the User ensure that they are working on the correct file for the correct project. The system will also pre-populate and/or pre-calculate the data for the PR to prevent the User from having to manually enter the SoV info or re-key previously entered data. If changes are made to a previous PR that affect the data within this PR, a new version of this PR will automatically be created and the new version will contain the now updated, pre-calculated data. To calculate this information, the system applies pre-written formulas (defined below) to calculate the financial values that represent the progress made in the previous billing period and the current billing period.

It is important to note that these formulas will update the information on the Users screen in real-time (as they directly make edits to the page) so the user can see how their input changes the overall data as they make adjustments, which ensures the User does not have to calculate this information manually or outside of the system.

If this is the first time a PR is being created for a project, the User can import the SoV from an SoV Template created within the system, or from a spreadsheet created externally from the system, or they can build the SoV manually while working on the PR itself. Afterwards, when the User creates each sequential PR, the system will automatically populate the SoV info when that PR is created to prevent the User from having to manually re-key data. During the course of the project, the User can makes changes to the SoV, as needed, including the Display Order, the Category and Description 151 names, the Scheduled Value 152, and the Total Units.

When the User creates the PR, the system will populate the data for the column labeled “From Previous Payment Requests” 153, using the following formula:

PrevPR=TCS from the Previous Payment Request

Where PrevPR is the cumulative value of progress for each line item within the SoV based on previously reported progress; TCS is the cumulative value of progress that was calculated when the previous PR was created. If this is the first PR on a project, then there is no previous progress and PrevPR will=0.

When the User creates the PR, the system will populate the data for the column labeled “% Complete Thru this PR” using the following formula:

PCa=PrevPR/SoV

Where PrevPR is the cumulative value of progress for each line item within the SoV based on previously reported progress; and SoV is the dollar value assigned to the line item. If this is the first PR on a project, then there is no previous progress and PCa will=0. (It is important to note that the sum of the SoV Amount for each line item is expressed as TotalSoV, which is also equal to the contract amount previously established for the project when entering their total project amount 77.)

The value in “Units Complete Thru this PR” corresponds directly with the “Percent Complete thru this PR” column, but is expressed as a numeric integer rather than a percent.

The User can now record values for Percent Complete or Units Complete to denote the sum of Work Progress made for any previous billing periods and the current billing period 154. If the user enters data into the Percent Complete column, the Units Complete column will display the corresponding value, or vice versa, using the following formula:

UC=P*SoVu

Where UC is the Units Complete; PC is the Percent Complete expressed as a decimal; and SoVu is the total number of units assigned to the line item as defined in the Schedule of Values (SoV).

Mathematically, data within the Percent Complete or Units Complete fields are handled the same way and enable the system to calculate the Work Progress Amount for the current period, not including Stored Materials 156, using the following formula:

PA=TCS−PrevPR−SM

Where PA is the value for the Work Progress Amount This Period (not including Stored Materials); TCS is the value for Total Completed and Stored for the line item; PrevPR is the cumulative value of progress for each line item; and SM is the value of Stored Materials for the line item

When the User creates the PR, the system will populate the data for the column labeled “Total Completed & Stored”, based on the following formula:

TCSa=(Sum of Previous Work Completed Dollar Amount)+(Sum of Previous Stored Materials Amount)

Where TCSa is the original value for Total Completed and Stored when the new PR was first created. If this is the first PR on a project, then there is no previous progress and TCSa will=0.

The elements for these sums are as follows: 1) Sum of Previous Work Completed Dollar Amount is the Sum of Previous Work Completed progress in decimals multiplied by the SoV Amount; 2) Sum of Previous Stored Materials Amount is the sum of the dollar amount of Stored Materials from all previous PRs.

As the user enters values for Percent Complete 154 (or Units Complete) and/or Stored Materials 155, the system will automatically calculate the Total Completed and Stored 157 using the following formula:

TCS=(Sum of Previous Work Completed Dollar Amount)+(Sum of Current Work Completed Dollar Amount)+(Sum of Previous Stored Materials Amount)+Current Materials Stored

Where TCS is the now updated numeric value for Total Completed and Stored. The elements for these sums are as follows: 1) Sum of Previous Work Completed Dollar Amount is the Sum of Previous Work Completed progress in decimals multiplied by the SoV Amount; 2) Sum of Current Work Completed Dollar Amount is the PRWorkCompletedPercent expressed as a decimal multiplied by the SoV Amount; 3) Sum of Previous Stored Materials Amount is the sum of the dollar amount of Stored Materials from all previous PRs; 4) Current Materials Stored is the value for the SM for this PR.

When TCSa or TCS is calculated, the system will convert this number and display it as “Percent Completed” using the following formula:

PC=(TCS/SoV)*100

Where PC is the Percent Complete; TCS is the Total Completed and Stored; and SoV is the Scheduled Value of the Line item. That value is then multiplied by 100 to be expressed as a percent.

When the User creates the PR, the system will populate the data for the column labeled “Balance to Finish” 158, based on the following formula:

BTFa=SoV−TCSa

Where BTFa is the original value for Balance to Finish; SoV is the Scheduled Value of the Line item; and TCSa is the original value for Total Completed and Stored when the new PR was first created. If this is the first PR on a project, then there is no previous progress and BTFa will=SoV.

As the user enters values for Percent Complete 154 (or Units Complete) and/or Stored Materials 155, the system will automatically calculate the Balance to Finish 158 using the following formula:

BTF=SoV−TCS

Where BTF is the now updated value for Balance to Finish; SoV is the Scheduled Value of the Line item; and TCS is the updated value for Total Completed and Stored.

When the User creates the PR, the system will populate the data for the column labeled “Retainage” 159, based on 1) the contract amount (which equals the sum of the values for SoV); 2) the Retainage Rules that were previously defined for the project for Work Progress and for Stored Materials for that particular GC or SubContractor; 2) the Change Order Retainage settings for that particular GC or SubContractor (which determines whether retainage will or will not be withheld for Change Orders); and 3) the following logical formula:

The system calculates the retainage to be withheld by first identifying the Minimum and Maximum values for the Work Progress and Stored Materials Retainage Billing Thresholds, which enables the system to identify the maximum amount of money to withhold for each retainage percentage. The retainage value to withhold is then calculated based on the value of the Work Performed plus the Stored Materials multiplied by the retainage percentage.

It is important to note that a SubContractor User may have limited editing capabilities on a PR's Billing Worksheet (FIG. 11) and/or other data entry tabs, dependent on whether a GC or SubContractor User created the “parent” project record and/or based on the status of the PR. If the GC created the “parent” project record, then the SubContractor User will not be allowed to change specific information, such as the Change Order Amount, the Contract Amount, or the names of the GC's 4 personnel who are eligible to approve the PR. However, If the SubContractor created the “parent” project record, then the SubContractor User has full control over the PR and can edit this information, as needed.

It is important to note that the GC User and/or the SubContractor User has full control over the SoV within a PR. Either User can change the Display Order, the Category, the Description of Work, and/or the Scheduled Value Amount at any time, provided that these changes to the latter do not cause the sum of the amounts to be unequal to the SubContractor's total contract amount or violate industry best practices.

As noted in FIG. 8, the SubContractor will submit Payment Requests (PRs) to the GC for review and approval 106, which enables the GC to add these PRs to a Merged Billing 103 that can then be sent to the Owner/Developer.

FIG. 12 depicts the Billing Worksheet for a Merged Billing, which provides a centralized location for the GC to view and modify the PR billing info for a specific billing period, which includes the PRs from the SubContractors on the Project as well as the GC's own PR. The invention provides the ability for this information to be modified from a centralized location to enable the User to perform these changes more efficiently. However, the User can optionally choose to update the PR information for each SubContractor individually, as shown in FIG. 11.

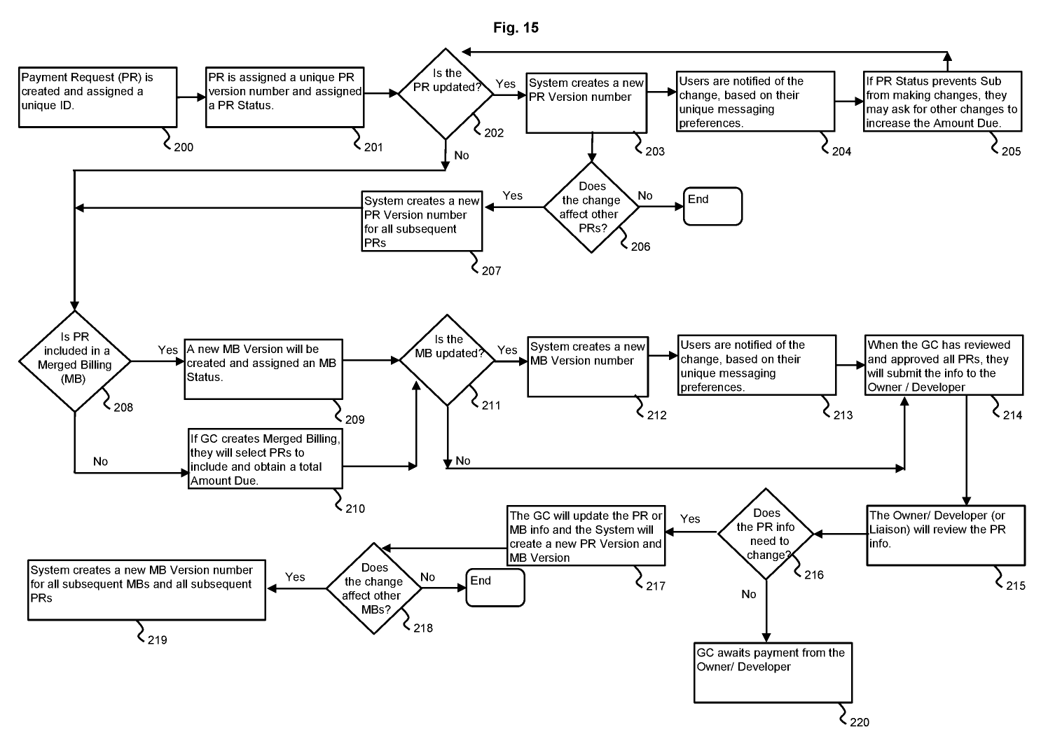

When the GC is satisfied that the billing information is correct, he will notify the Owner/Developer and provide access to a digital copy and/or report. As the Owner/Developer reviews the billing information, he may ask the GC to make changes. (The change process is defined below, in FIG. 15.) Eventually, the GC and Owner/Developer will come to an agreement on the billing information and will agree to a payment amount 111 and the GC will now await payment 112.

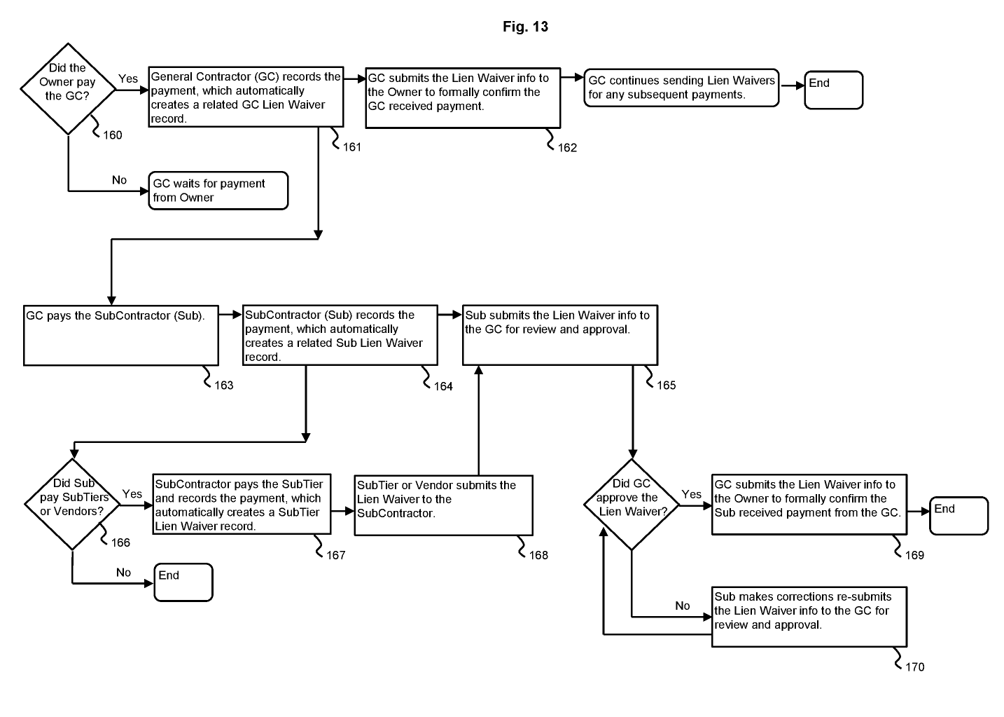

FIG. 13 depicts the payment process, which originates with a payment from the Owner/Developer to the GC (GC) 160. When a payment has been made 161, the GC will record the payment and the invention will automatically create a placeholder record for the GC Lien Waiver 161. The GC will collect the necessary information and submit the completed Lien Waiver information to the Owner to confirm that the payment was received 162. In the meantime, the GC will also pay the SubContractors 163, who will record the payment so the system can automatically create a placeholder record for the SubContractor Lien Waiver 164. The SubContractor will collect the necessary information and submit the completed Lien Waiver information to the GC to confirm that payment was received 165. The GC will review the Lien Waiver info from the SubContractor to ensure that the correct documents were sent and that any supporting documents or photos were included 165. If the GC approves the Lien Waiver, the information will be provided to the Owner/Developer 169. If the GC does not approve the Lien Waiver, the SubContractor will make corrections and re-submit the Lien Waiver info for review and approval 170.

If a SubContractor used Sub-Tiers or other Vendors (FIG. 1; 6) for the work that was recorded within a Payment Request 166, then the Sub will now pay these companies 167 and the invention will automatically create a placeholder for a Sub-Tier Lien Waiver record. The Sub-Tier/Vendor 6 will collect the necessary information and submit the completed Lien Waiver information to the SubContractor to confirm that payment was received 168. The SubContractor will review and submit this information to the GC 165, who will review it to ensure the information is accurate and complete. If the GC approves the Lien Waiver, the information will be submitted to the Owner/Developer 169. If the GC does not approve the Lien Waiver, the SubContract, Sub-Tier, or Vendor will make corrections and re-submit the Lien Waiver info for review and approval 170.

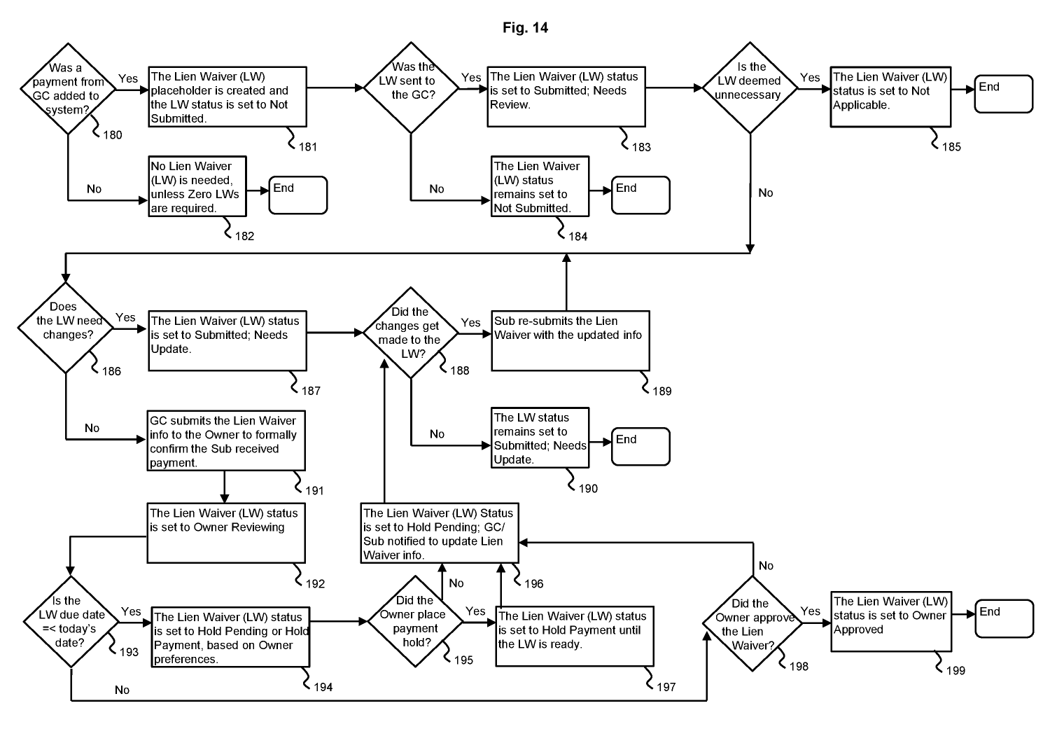

FIG. 14 depicts the Lien Waiver Review Process for SubContractor and Sub-Tier Lien Waivers. When the GC issues a payment to the SubContractor 180, the SubContractor will record the receipt of the payment and specify how the how that payment was distributed among one or more PRs, and/or for a retainage payment, and/or will be distributed amongst the Sub-Tiers and Vendors. When the new payment is logged, the system will automatically create Lien Waiver placeholder records and assign a status a Lien Waiver Status that can be used to help track Lien Waivers for SubContractors and Sub-Tiers/Vendors during the review and approval process.

More specifically, when a SubContractor receives a payment from the GC and adds it to the system 180, a Lien Waiver (LW) placeholder record is created and assigned a status of “Not Submitted” 181 and remains at that status until it is submitted 184. When the SubContractor submits the LW to the GC, the status is automatically set to Submitted; Needs Review 183. If the LW was deemed unnecessary, the LW status can be changed to “Not Applicable” 185.

It is important to note 182 that the Owner/Developer may require the GC, SubContractor, and/or Sub-Tiers/Vendors to provide Zero Lien Waivers during a specific billing period. The system supports requirements for Zero Lien Waivers by enabling a User to log a payment for $0, then submitting the previously defined Lien Waiver process for GCs, SubContractors, and/or Sub-Tiers/Vendors.

If the LW submitted to the GC needs changes 186, the LW status can be changed to “Submitted; Needs Update”, 187 which will notify the SubContractor that changes needs to be made 188 and the status will remain at this setting until the changes are made 190. Eventually, the SubContractor will make the necessary changes and re-submit the LW with the updated information 189. The GC can now review the LW again to determine if further changes need to be made 186.

When no further changes are needed, the GC will submit the LW info to the Owner 191 and the LW status will automatically be set to “Owner Reviewing” 192. If the Due Date for the LW has passed, the LW's status will automatically be assigned a status classification of “Hold Pending” or “Hold Payment” based on the Owner/Developer's preference for the project 194. If the Owner/Developer does not want payments to be held 195, the LW status is set to “Hold Pending” 196 and the GC and/or SubContractor will be notified so that Lien Waiver can be submitted or updated, as necessary 196. If the Owner/Developer does want payments held, the LW status will set to “Hold Payment” until the LW is ready 197.

When the Owner receives the LW, they will review the information submitted to ensure the information is accurate and complete, which determines whether the LW will be approved or not 198. When the Owner is satisfied that the LW info is correct, the LW status is set to “Owner Approved” 199 and the Lien Waiver is considered closed.

FIG. 15 illustrates the procedural logic used to update Payment Requests and Merged Billings and link them together, so that changes to a previous Payment Request will be updated and synchronized with subsequent Payment Requests and Merged Billings. When a Payment Request is first created for a specific billing period, it is assigned a unique ID 200 and a unique PR Version ID and PR Status 201. If the PR is updated 202, the system will create a new PR Version number for the Payment Request 203. Users may be notified of the change, based on their unique messaging preferences 204. If the PR Status prevents the SubContractor from making further changes to the PR, they may ask for other changes and/or negotiate for an increase in the amount to be paid 205.

The system will determine if the change affects other Payment Requests 206. If it does not, the updates are complete. If it does, then the system will create a new PR version number for all subsequent PRs 207.

If the PR is included in a Merged Billing (MB) 208, a new MB Version will be created and assigned an MB Status 209. If the PR is not included in a Merged Billing, the GC will continue to review PRs until they are ready to create a Merged Billing and select the PRs that are ready to be submitted to the Owner for review and approval 210. If the GC updates the Merged Billing 211, a new MB Version will be created 212 and Users may be notified of the change, based on their unique messaging preferences 213. When the GC has reviewed and approved all PRs, they will submit the info to the Owner/Developer 214, who will review the PR info directly or delegate this task to a Liaison 215.

If the Owner/Developer believes the PR info needs to change 216, the GC will update the PR info 217. The system will create a new PR Version number and a new MB Version number. If the change affects other MBs 218, the system will create a new MB Version number for all subsequent MBs and all subsequent PRs 219.

If the Owner/Developer believes the PR info does not need to change 216, the GC will await payment from the Owner/Developer.

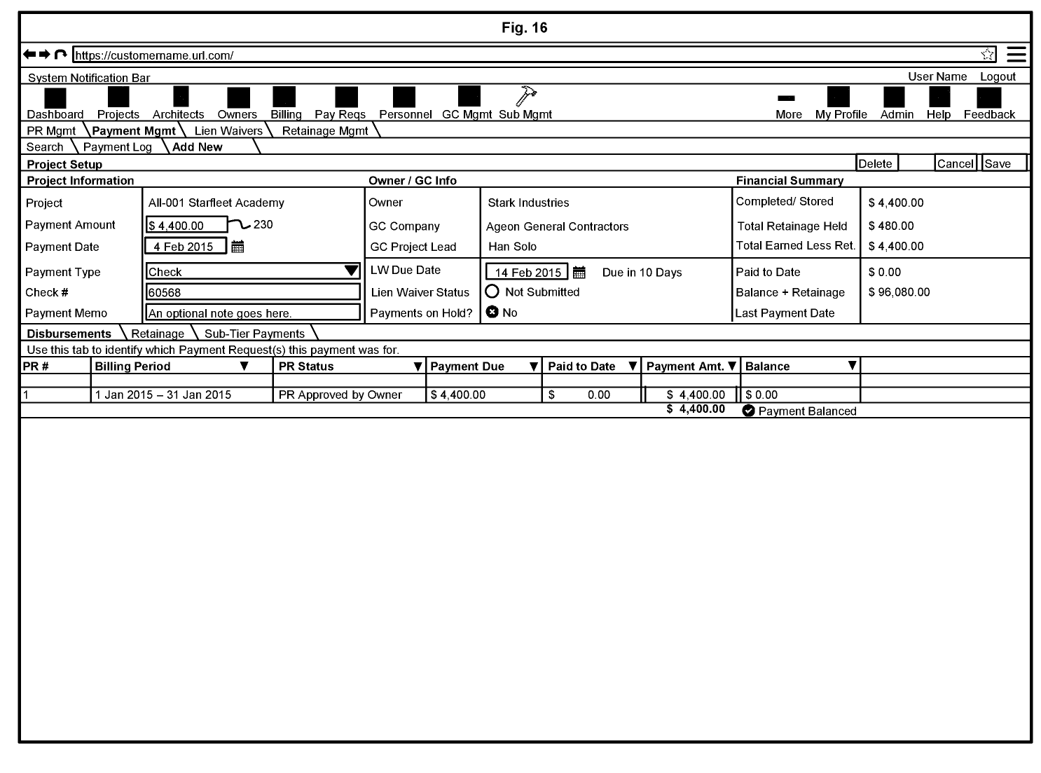

FIG. 16 depicts the Disbursements tab on the payment management screen, which enables a SubContractor to record payments related to Payment Request(s) 164.

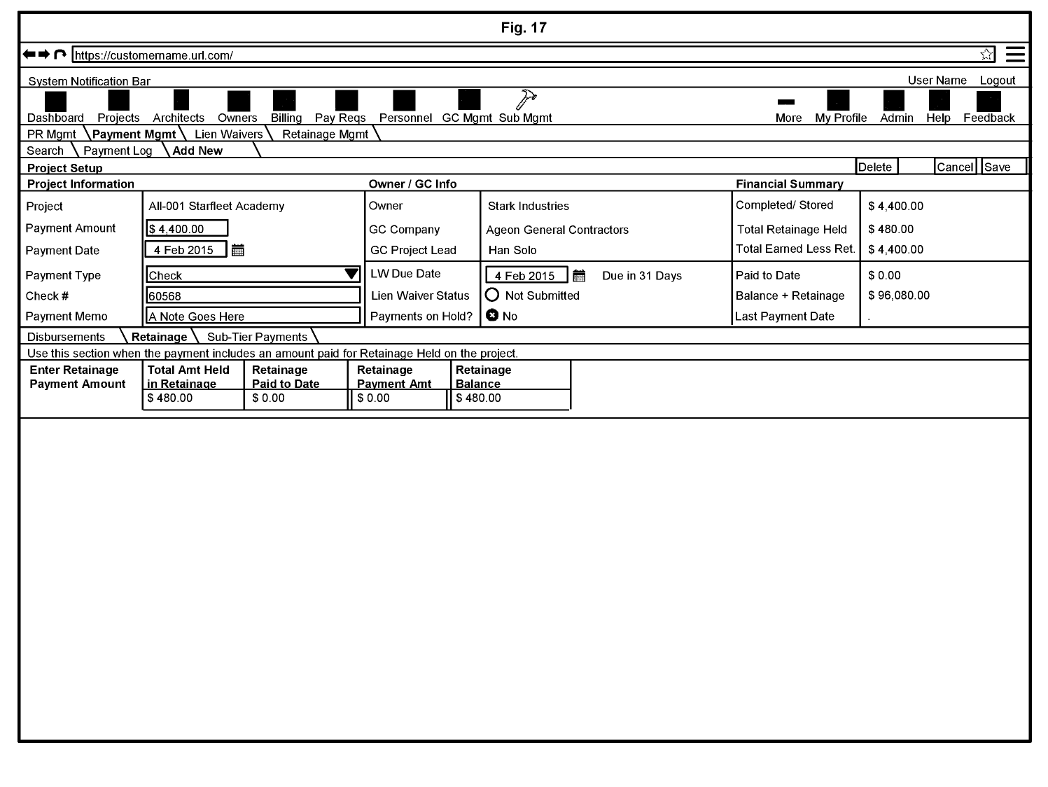

FIG. 17 depicts the Retainage tab on payment management screen, which enables a SubContractor to record payments related to retainage withheld.

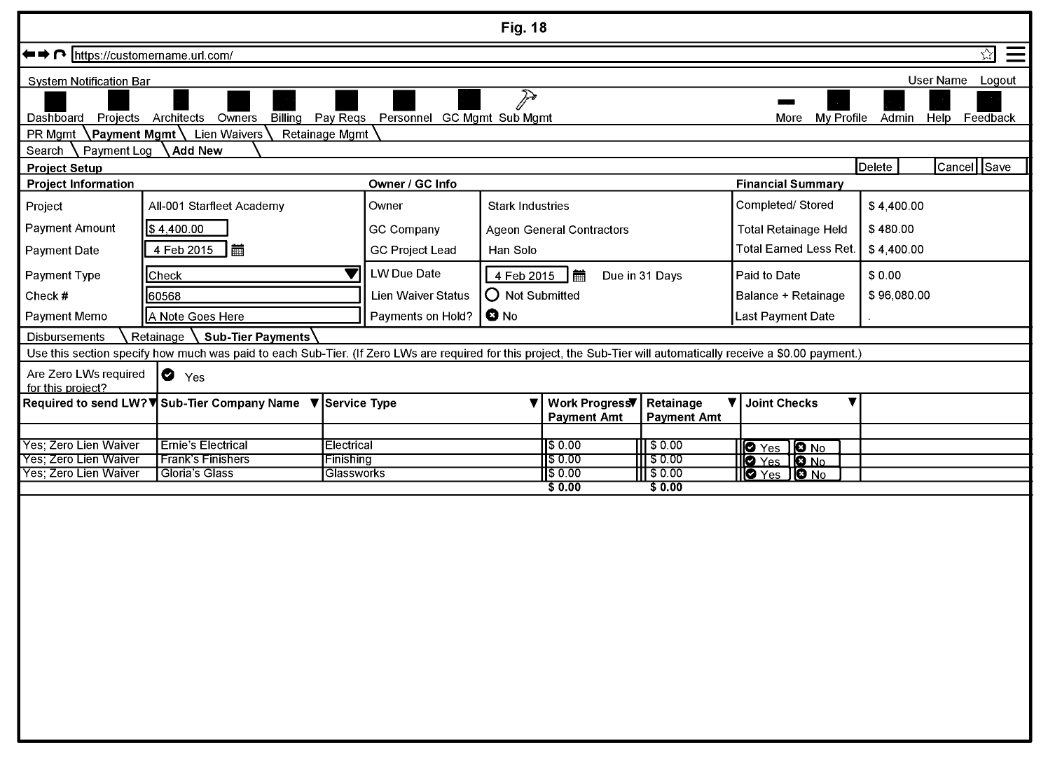

FIG. 18 depicts the Sub-Tier Payments tab on payment management screen, which enables a SubContractor to identify how payments will be distributed amongst the Sub-Tiers or Vendors on a project 167.

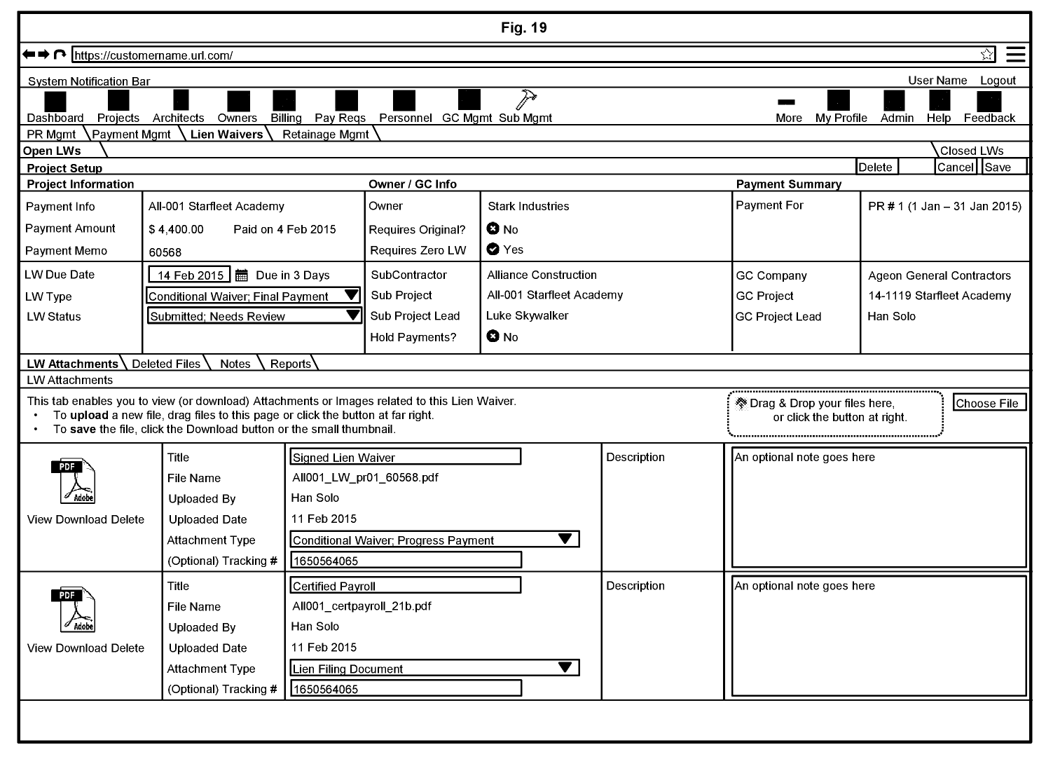

FIG. 19 depicts the lien waiver screen, which enables a SubContractor to view the payment info related to a Lien Waiver and to provide the Lien Waiver documents that are required by the GC and/or Owner/Developer to acknowledge the receipt of payments received.

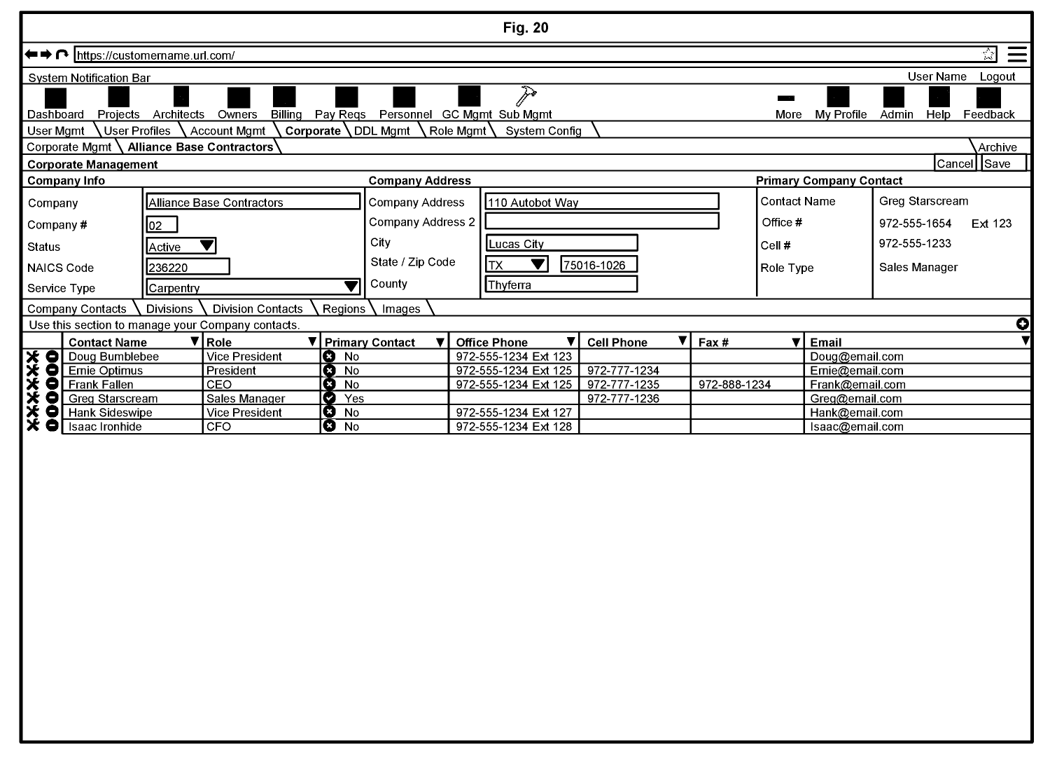

FIG. 20 illustrates the graphic user interface where a User can manage their Company Contacts 68.

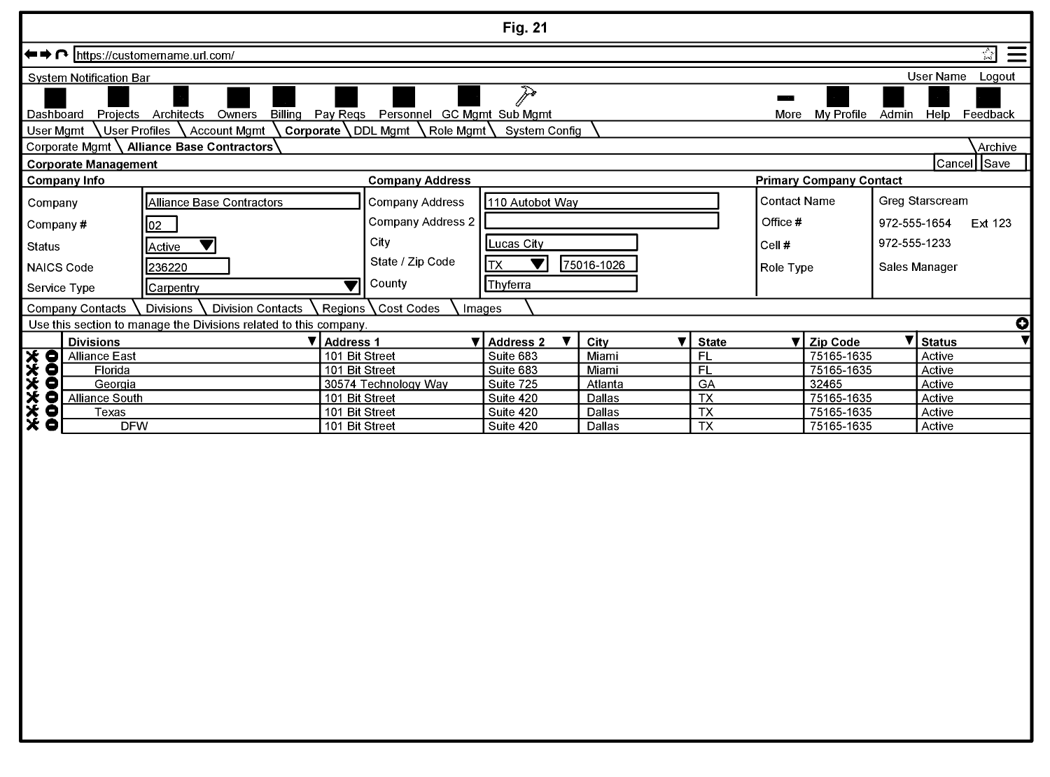

FIG. 21 illustrates the graphic user interface where a User can manage their Corporate Hierarchy for Companies 65 and Divisions 66.

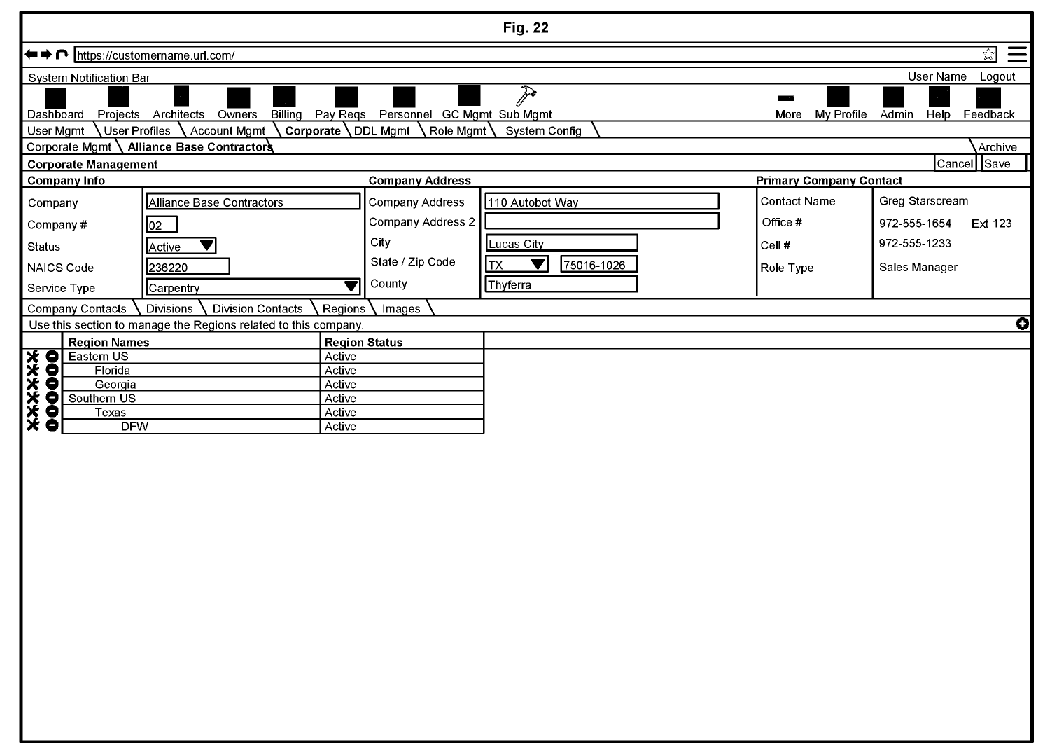

FIG. 22 illustrates the graphic user interface where a User can manage their Regions 67.

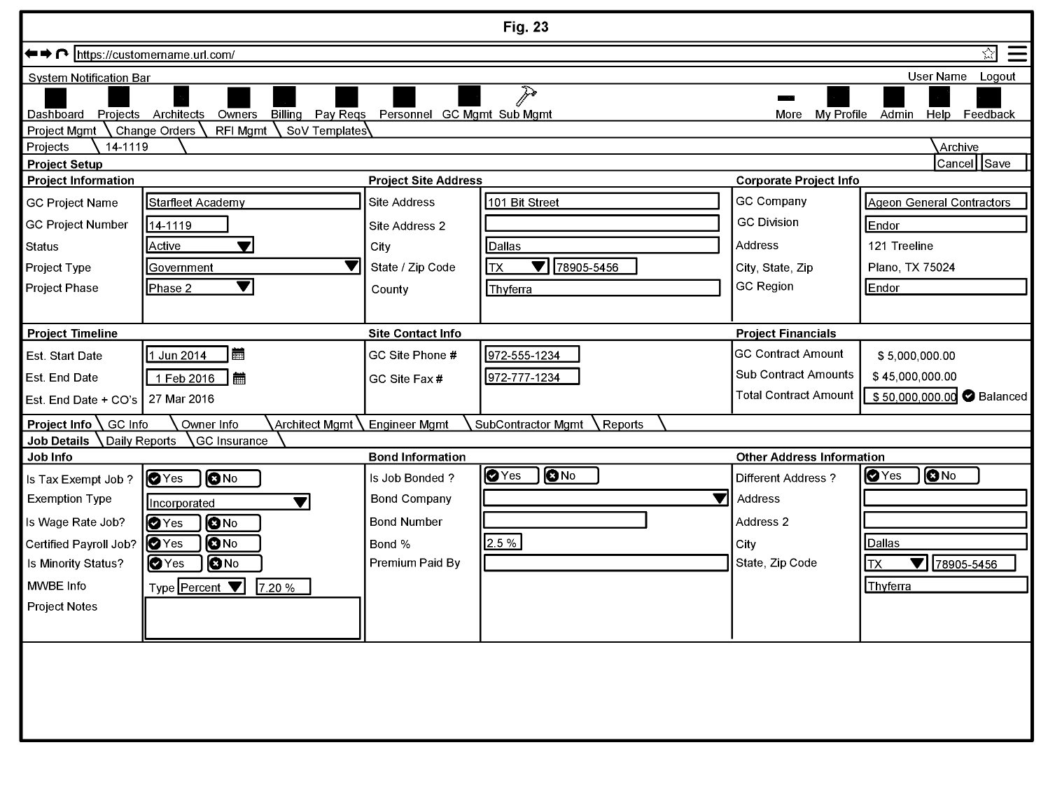

FIG. 23 illustrates the graphic user interface where a General Contractor User can manage basic information about a project.

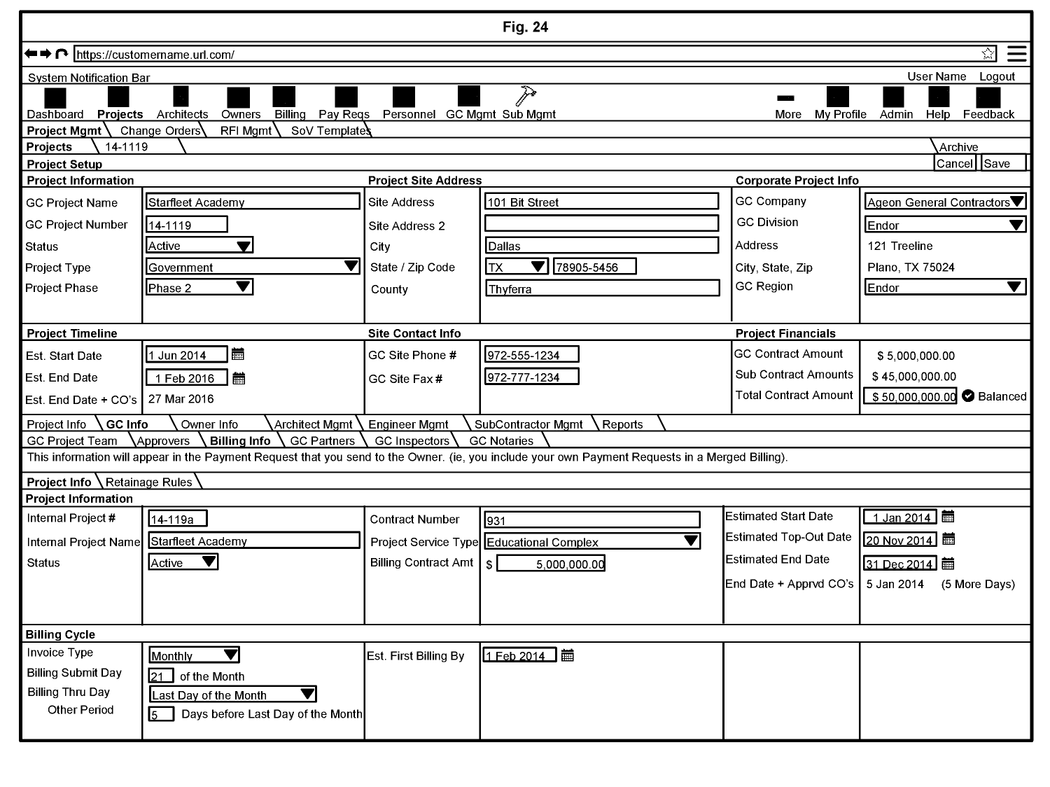

FIG. 24 illustrates the graphic user interface where a General Contractor User can manage basic information that will be used when submitting Payment Requests 73.

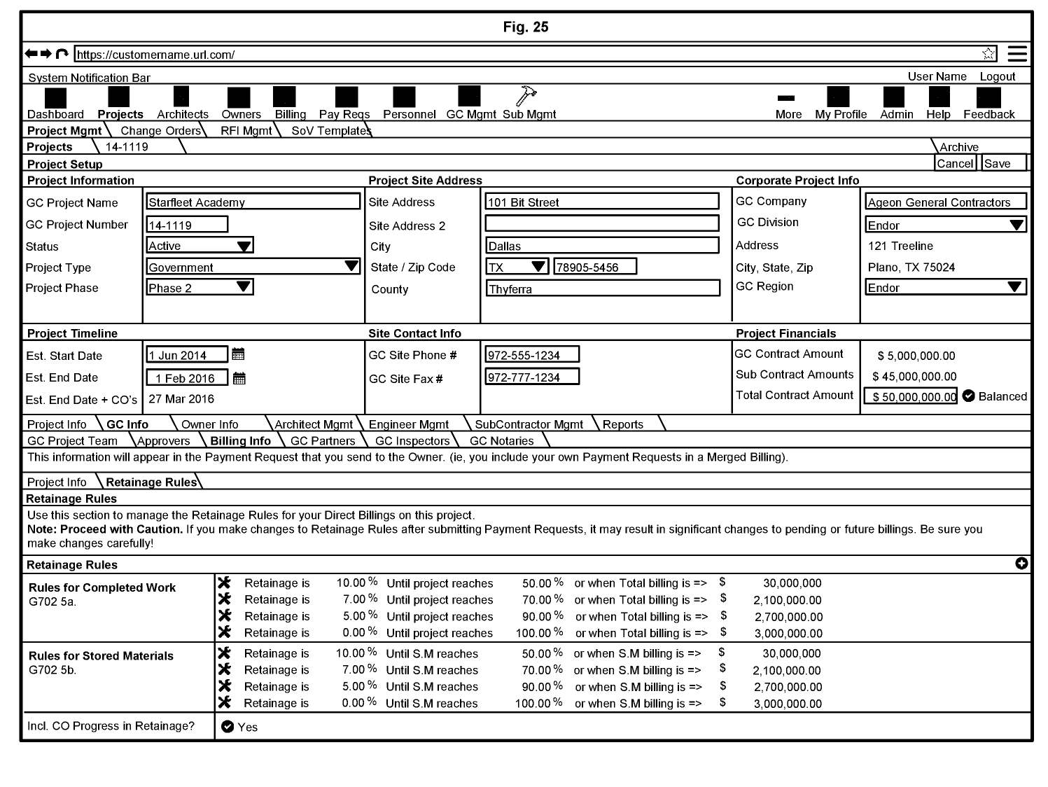

FIG. 25 illustrates the graphic user interface where a General Contractor User can manage basic information that will be used to calculate retainage holdings for the PRs that the GC will submit for their own work on a project 77, such as their Schedule of Values 95, PR approvers 85, Notary Public Approvers 86, and if necessary, Inspector Approvers 87.

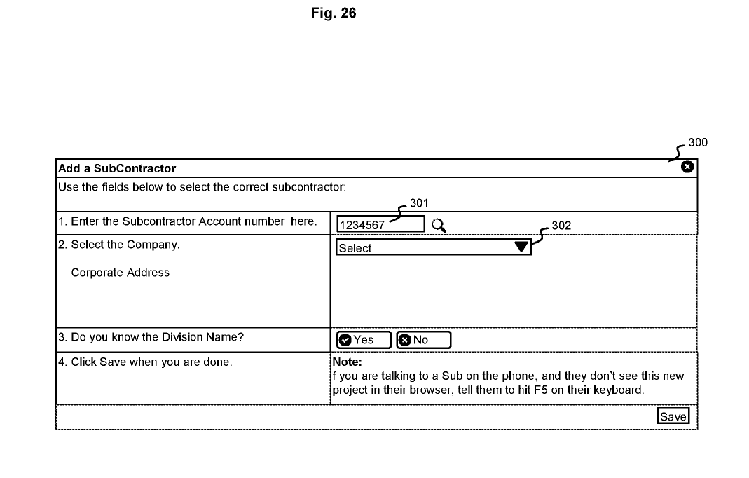

FIG. 26 illustrates the graphic user interface where a General Contractor User can add a SubContractor to a project by using that Customer's globally unique identifier (GUID) 74. From the main screen (shown in FIG. 7), the GC User will open a pop-up 300 and enter the Subcontractor's GUID into the appropriate field 301. The User will then perform a search and will see the name of the company (or companies) related to that GUID 302. Once the User clicks the Save button, the SubContractor will be part of the project and can begin updating his own project info 73.

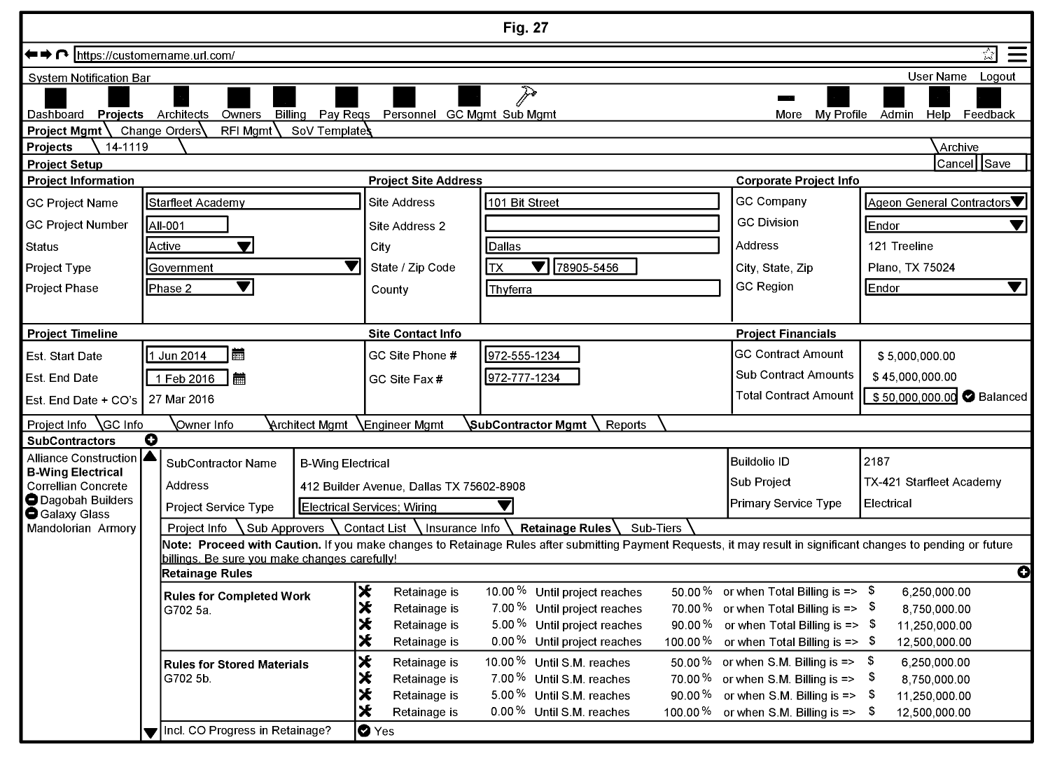

FIG. 27 illustrates the graphic user interface where a General Contractor User can manage basic information that will be used to calculate retainage holdings for the PRs that a SubContractor will submit for their work on a project.

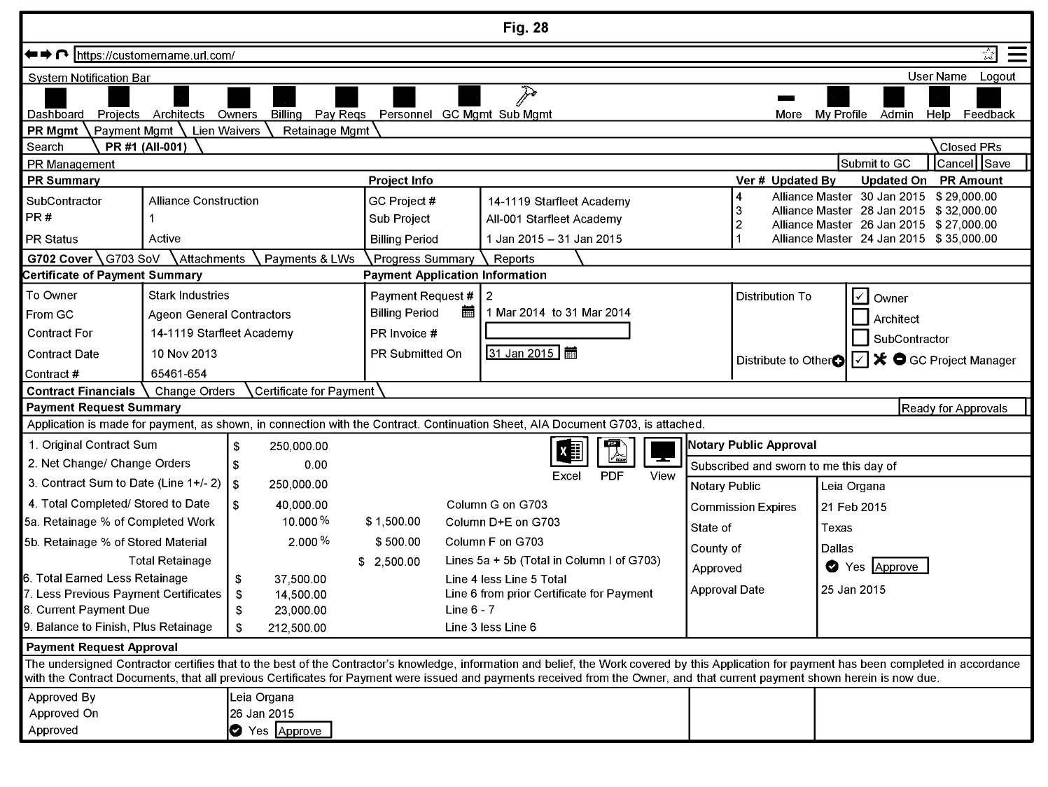

FIG. 28 illustrates the graphic user interface where a General Contractor or SubContractor User can view a summary of the mathematical calculations related to the current payment request and its relationship to previously submitted payment requests.

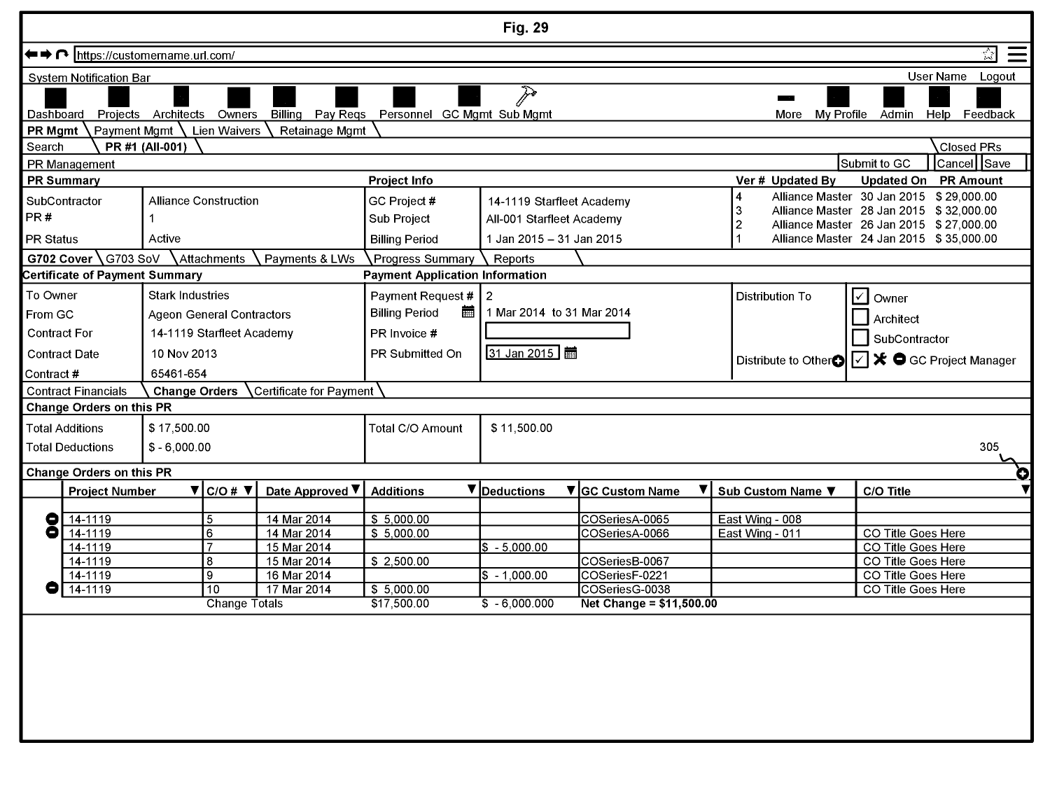

FIG. 29 illustrates the graphic user interface where a General Contractor or SubContractor User can see a summary of the Change Orders that were added to a Payment Request. If a User discovers that a Change Order is missing and should be added, they will click on the “Add Change Order” button 305.

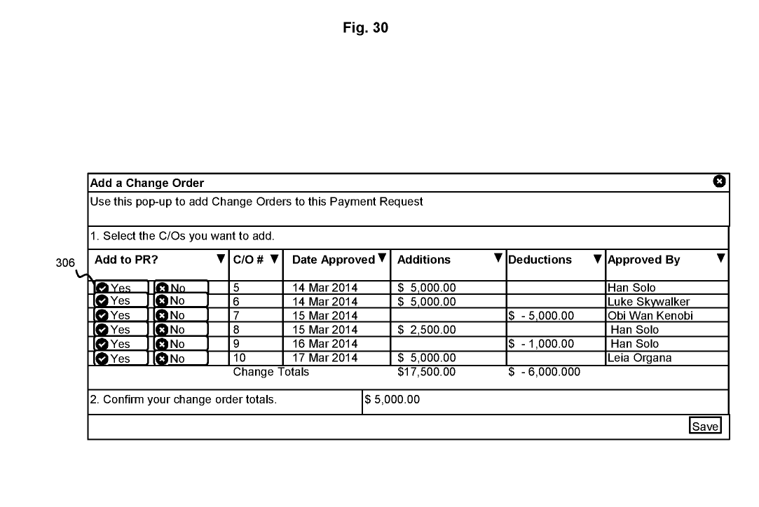

FIG. 30 illustrates the graphic user interface where a General Contractor or SubContractor User can select add a Change Order to a Payment Request by clicking on the Yes button to select one or more Change Orders 306.

1. A method of managing project information using network-based software, the method comprising the acts of:
creating a Customer account record to identify the corporate entity (or entities) that will participate in a project
creating one or more User Accounts for the corporate personnel that will participate in projects, manage the information, and perform data entry
creating a project record and storing information that includes information about the project, project contacts, and preferences for the general contractor, subcontractor, owner/developer, general contractor partner, architect, and/or engineer.
relating contract information to the said project record for the general contractor and subcontractor, including contract documents, contract amounts, retainage billing preferences, and settings for retainage withholdings
creating change orders related to said project record that can be included in in requests for payments or other informational purposes

2. A method for a payment recipient to manage the work items that appear in requests for payments, the method comprising the acts of:
creating and managing a schedule of values online using a web-connected graphical user interface or by importing data from an external file, where the schedule of values is used to identify the units of work to be performed on a project, consisting of an item number, an optional category, a description of work, a scheduled value amount, and the number of units related to the work item
relating a schedule of values to a specific project record

3. A method for a payment recipient to update billing information for said payment requests, the method comprising the acts of:
creating a payment request online for a specific billing period, based on said schedule of values, whereby the user may input billing information directly into the graphical user interface to record work progress completed, or units completed, and/or the value of stored materials
relating said payment request to said project
providing the ability to add one or more change orders to said payment request, so that it may include additional work items that were not identified within said schedule of values
assigning the status of payment requests that were submitted for review and approval
creating a version for each payment request to uniquely define the collection of said schedule of values and said change orders

4. A method for a payment recipient to synchronize the mathematical data for payment requests across multiple billing periods, the method comprising the acts of:
the method of claim 3 wherein changes to a previous payment request for a project will result in the creation of a new version of subsequent payment requests so that mathematical formulas can be re-calculated and applied to the newly created versions

5. A method for a payment recipient to combine multiple payment requests into a single billing, the method comprising the acts of:
creating a merged billing online for a specific billing period for a project, comprised of the payment requests from the payment recipients on said project
the method of claim 4 wherein changes to a previous payment request for a project will result in the creation of a new version of subsequent merged billings so that mathematical formulas can be re-calculated and applied to the newly created versions

6. A method for a payment recipient to store information related to payments received from a payee, the method comprising the acts of:
creating a payment record to identify a payment received from a payee
mapping said payment to a project

7. A method for a payment recipient to store information about lien waivers related to said payments, the method comprising the acts of:
creating a lien waiver record to acknowledge a payment for a project received from a payee
mapping lien waiver to said payment so that the status of reviews and approvals can be tracked
